(19) United States
(12) Patent Application Publication
(10) Pub. No.: US 2026/0259150 A1
(43) Pub. Date: Sep. 3, 2026

(54) MONITORING A MECHANISM CONTAINING A SPRING

(71) Applicant: ODYSIGHT.AI LTD., Omer (IL)

(72) Inventors: Amir GOVRIN, Ramat Gan (IL); Yekaterina DLUGACH, Mabuim (IL); Arik PRIEL, Givat Shmuel (IL); Shoham BEN SHOSHAN, Meitar (IL)

(21) Appl. No.: 18/995,800

(22) PCT Filed: Jul. 31, 2023
(86) PCT No.: PCT/IL2023/050795

§ 371 Date: Jan. 16, 2025

Related U.S. Application Data
(60) Provisional application No. 63/394,138, filed on Aug. 1, 2022.

(51) Int. Cl. G01N 21/95; G01N 21/88; G06T 7/00

(52) U.S. Cl. CPC G01N 21/95; G01N 21/8806; G06T 7/0006; G01N 2021/8838; G06T 2207/30164

(57) ABSTRACT

A system for monitoring a mechanism includes processing circuitry. The mechanism contains a spring. The processing circuitry inputs image data of at least one section of the spring from one or more optical sensors and provides an indicator of the health of the mechanism based on an analysis of the image data.

### TECHNICAL FIELD

The present disclosure, in some embodiments, thereof, relates to monitoring the health of a mechanism, and, more particularly, but not exclusively, to monitoring a mechanism comprising a spring.

### BACKGROUND

Machine maintenance may include any work that maintains the mechanical assets running with minimal downtime to the machine and/or a component of the machine. Machine maintenance often includes regularly scheduled service, routine checks, and both scheduled and emergency repairs. Maintenance may also include replacement or realignment of parts that are worn, damaged, or misaligned. Machine maintenance may be done either in advance of failure or after failure occurs. Machine maintenance is critical at any plant or facility that uses mechanical assets. It helps organizations meet production schedules, minimize costly downtime, and lower the risk of workplace accidents and injuries.

Today, industrial maintenance often functions automatically over a set period of time (periodic maintenance) based on statistical and/or historic data, based on a certain level of use (for example mileage or a number of engine hours or number of users), or when a machine, part or component fails (breakdown maintenance). This type of maintenance is often wasteful and inefficient and may not catch problems as they arise in real-time or predict the potential for failure.

In some cases, predictive maintenance is also based on signals or other data provided by sensors. However this data is often linked to the state of a specific component of a machine or system and is therefore of limited use in establishing a maintenance protocol for the entire machine or system.

Components of machines or structures connected to springs, such as suspended observation systems, tall buildings, bridges, shock absorbers, dampers, overhead power lines, cantilevered signs, etc. may be affected by forces arising from winds, earthquakes, vibrations from traffic (both pedestrian and vehicle) or by oscillation of or collision with other objects connected to them. The forces may be low grade, continuous or extreme, and may cause direct or indirect damage. Additionally, internal damage is often invisible from the outside and maintenance checks may not catch such issues.

Thus, there is a need in the art for more efficient strategies of maintenance of spring-based systems.

### SUMMARY OF THE INVENTION

According to some embodiments there is provided a system, a method, and a computer program product for monitoring a mechanism which includes a spring. The health of the mechanism is evaluated by analyzing image data obtained from optical sensors viewing the spring. An indicator of the health of the mechanism is output based on the results of the analysis.

In some embodiments, the image data is analyzed to determine the value of parameters related to the spring. These values may be compared to specified range(s) and/or threshold(s) in order to determine whether the mechanism is functioning within permitted norms. If not, the indicator may provide information that a fault or failure is suspected or has occurred.

Optionally, when the mechanism has undergone stress, the indicator includes data related to this stress. The stress-related data may be used to adjust the maintenance protocol for the mechanism or associated element(s) and may lead to earlier or even immediate maintenance.

Another aspect of the spring image data that may be analyzed is the relative motion of the coils. For example, reference points may be identified on adjacent coils. When the spring is oscillating the distance between the reference points will increase and decrease. Thresholds may be set for the maximum/minimum distance between the reference points and the speed at which they move relative to each other. When these thresholds are exceeded, the analysis may find that an anomalous event has occurred, and the indicator may include information about the event.

The health of the spring itself may be a contributing factor to the health of the entire mechanism. Optionally, analyzing the image data further includes monitoring the health of the spring.

In one example, the analysis includes comparing the shape of the spring as a whole and/or the shape of the coils themselves to a model of the spring (e.g. expected dimensions). A deformation of the spring may indicate that the mechanism has been physically damaged.

In a second example, the image analysis may monitor the surface of the spring (e.g. spring coils) to identify excessive wear or irregularities which may be indicative of improper operation or malfunction of the mechanism.

Optionally, information about the health of the mechanism is provided to a predictive maintenance system, such as Prognostic Health Management (PHM), Condition-based Maintenance (CBM) and Health & Usage Monitoring Systems (HUMS).

Monitoring the spring accurately and over time may enable identifying and/or predicting a fault in the mechanism before it has become acute. Thus the occurrence of such faults may be avoided by preventive maintenance.

Some embodiments of the invention provide a technical solution to the technical problem of detecting faults early to eliminate failures of the system. A technical solution may be to use condition-based maintenance. In condition-based maintenance, the condition of the mechanism is monitored using the image data and maintenance actions are performed when specified conditions are identified (such as the occurrence of excessive stresses on the mechanism). Early maintenance may prevent future failure.

Some embodiments of the invention provide a technical solution to the technical problem of monitoring a mechanism in locations under severe space constraints. A technical solution may be to use a single small optical sensor positioned close to the mechanism. For example, an optical sensor positioned 2 cm from a coil of the spring may capture image data of multiple coils, which may provide sufficient information to determine aspects of the operation of the mechanism.

Some embodiments of the invention provide a technical solution to the technical problem of monitoring a mechanism which is surrounded by a housing. A technical solution may be to place an optical sensor (and optionally a light source) within the housing, so that image data may collected even when the spring is not visible from the exterior.

Effects of the invention may include but are not limited to:
1) Early detection of faults and failures;
2) Rapid detection of acute failures;
3) Real-time control of the mechanism or an associated element in response to a detected fault and/or failure;
4) Preventive and predictive maintenance may be based on the progression of the range of motion over time;
5) Condition-based monitoring by monitoring conditions in which the mechanism operates;
6) Suitable for monitoring many types of systems and devices, including manufacturing machinery, vehicles, aircrafts and many more.
7) May be used in a wide range of environmental conditions.
8) Enables monitoring the mechanism in otherwise inaccessible areas by positioning the optical sensor(s) with a view of a spring or portions thereof that may not be monitored otherwise.

According to a first aspect of some embodiments of the present invention there is provided a system for monitoring a mechanism comprising a spring. The system includes processing circuitry configured to input image data of at least one section of the spring from at least one optical sensor and to provide an indicator of a health of the mechanism based on an analysis of the image data.

According to a second aspect of some embodiments of the present invention there is provided a method for monitoring a mechanism comprising a spring. The method includes:
inputting image data of at least one section of the spring from at least one optical sensor; and
providing an indicator of a health of the mechanism based on an analysis of the image data.

According to a third aspect of some embodiments of the present invention there is provided a non-transitory storage medium storing program instructions which, when executed by a processor, cause the processor to carry out the method of the second aspect and any embodiments thereof.

According to some embodiments of the invention, the indicator is indicative of a health of at least one component of the mechanism other than the spring.

According to some embodiments of the invention, the analysis includes detecting events that occurred to the mechanism.

According to some embodiments of the invention, at least one optical sensor is mounted within a housing covering at least some of the mechanism.

According to some embodiments of the invention, at least one light element is mounted within the housing and is positioned to illuminate at least a portion of at least one section of the spring during image data capture by the optical sensor.

According to some embodiments of the invention, the mechanism includes a damper configured to dampen oscillations of the spring.

According to some embodiments of the invention, at least one optical sensor is controlled to synchronize image data capture during a strobe light pulse.

According to some embodiments of the invention, the analysis includes determining, from the image data, a respective conformance of at least one parameter value of the spring to a specified range of the parameter. According to some embodiments of the invention, the at least one parameter includes a characteristic of a surface of a wire forming the spring. According to some embodiments of the invention, the at least one parameter includes an angle of coils of the spring. According to some embodiments of the invention, the at least one parameter includes a pitch of coils of the spring.

According to some embodiments of the invention, the analysis includes comparing a shape of a wire forming the spring to a baseline shape of the wire.

According to some embodiments of the invention, the analysis includes comparing an expected length of the spring under a known force to a current length of the spring.

According to some embodiments of the invention, the analysis includes comparing an expected length of the spring in an absence of force to a current length of the spring.

According to some embodiments of the invention, the analysis includes comparing a shape of the spring to a baseline shape of the spring.

According to some embodiments of the invention, the analysis includes calculating a movement of a reference point on the spring in multiple images.

According to some embodiments of the invention, the analysis includes comparing a rate of change of a distance between reference points on respective coils of the spring to an expected rate of change of the distance.

According to some embodiments of the invention, the analysis includes comparing a rate of change of at least one parameter of the spring to an expected rate of change of the parameter.

According to some embodiments of the invention, the analysis is further based on known physical properties of the spring.

According to some embodiments of the invention, the analysis is further based on known operating conditions of the spring.

According to some embodiments of the invention, the analysis is based on a single image.

According to some embodiments of the invention, the analysis is based on multiple images.

According to some embodiments of the invention, an operation of the mechanism is controlled based on the indicator, so as to prevent operation of the mechanism during failure.

According to some embodiments of the invention, the indicator is output to a controller configured to control an operation of the mechanism based on the indicator.

According to some embodiments of the invention, an operation of the mechanism is controlled in real-time based on the indicator.

According to some embodiments of the invention, the indicator is output to a preventive maintenance system configured to provide maintenance instructions based on the indicator.

According to some embodiments of the invention, the indicator is displayed on a user interface so as to alert a user of the health of the mechanism.

According to some embodiments of the invention, the indicator includes at least one of:
maintenance instructions;
a time to failure estimation;
a failure alert;
a trend towards failure; and
operating instructions in response to a detected failure.

According to some embodiments of the invention, the mechanism is calibrated so as to determine a baseline for the analysis.

According to some embodiments of the invention, the analysis further includes predicting a future health of the mechanism by performing trend analysis.

According to some embodiments of the invention, the indicator is retrieved from a data structure indexed, at least in part, by at least one parameter value of the spring.

According to some embodiments of the invention, the analysis is based on a machine learning model trained using a training set of images collected during operation of at least one of the mechanism and a similar mechanism.

According to some embodiments of the invention, the machine learning model is a neural network.

According to some embodiments of the invention, the training of the machine learning model is performed using a supervised learning algorithm.

According to some embodiments of the invention, the training of the machine learning model is performed using an unsupervised learning algorithm.

According to a fourth aspect of some embodiments of the present invention there is provided a system for monitoring a mechanism comprising a damper and a spring. The system includes processing circuitry configured to input image data of at least one section of a spring associated with the damper from at least one optical sensor and to provide an indicator of a health of the damper based on an analysis of the image data.

According to a fifth aspect of some embodiments of the present invention there is provided a method for monitoring a mechanism comprising a damper and a spring. The method includes inputting image data of at least one section of a spring associated with the damper from at least one optical sensor and providing an indicator of a health of the damper based on an analysis of the image data.

According to a sixth aspect of some embodiments of the present invention there is provided a non-transitory storage medium storing program instructions which, when executed by a processor, cause the processor to carry out the method of the fifth aspect and any embodiments thereof.

According to some embodiments of the invention, the optical sensor is mounted within the body of the damper.

According to some embodiments of the invention, the optical sensor is mounted within fluid of a viscous damper.

According to some embodiments of the invention, at least one light element is positioned to illuminate at least a portion of the at least one section of the spring during image data capture by the optical sensor.

According to some embodiments of the invention, the analysis includes determining, from the image data, a respective conformance of at least one parameter value of the spring to a specified range of the parameter.

According to some embodiments of the invention, the analysis includes determining events that occurred to the damper.

According to some embodiments of the invention, the indicator is indicative of a health of components of the damper other than the spring.

According to a seventh aspect of some embodiments of the present invention there is provided a system for monitoring the integrity and/or function of a mechanism, and optionally an associated element, thereto. The system includes at least one optical sensor, such as a camera, configured to be fixed on, in vicinity of, or within the mechanism, with a field of view encompassing at least one segment of the spring, and at least one processor in communication with the at least one optical sensor. The system may be configured to provide an indication of the integrity and/or well-functioning of the spring and/or object attached thereto.

Alternatively, and/or additionally, the system may be configured to provide an indication of potential failure in the mechanism, and optionally in an associated element, the spring, segment thereof and/or object attached thereto and/or in a function thereof. The system may further include a light source providing illumination of the spring and/or object attached thereto. Optionally, the illumination may be based on a light bulb, light-emitting diode (LED), laser, a fiber light source, fiber optic cable, and the like.

According to some embodiments, the system may be operable as a stand-alone system for monitoring the integrity and/or function of the mechanism, and optionally in an associated element. According to additional or alternative embodiments, the system may be operable as an additional or a back-up system for monitoring the integrity and/or function of the mechanism, and optionally in an associated element, if, and/or when, other sensors (such as pressure sensors) may be malfunctioning.

According to some embodiments, the systems disclosed herein may further include, in addition to one or more optical sensors (such as the cameras) other sensors, such as pressure sensors, temperature sensors, acoustic sensors, accelerometers, velocity sensors, etc. Optionally, a combination of sensors may result in a more accurate indication regarding the spring and/or object attached thereto.

According to some embodiments, the systems disclosed herein may include a plurality of sensors (e.g., a plurality of cameras or a combination of one or more cameras and one or more other sensors) such that each of the plurality of sensors acquires data from each relevant area such as joint/moving component/element of moving component/marking (e.g., line) etc.

According to some embodiments, the one or more optical sensors (e.g., cameras) of the systems for monitoring a mechanism, and optionally in an associated element disclosed herein, may have a field of view sufficient to capture all relevant spring segments and/or components (for example all moving elements).

According to some embodiments, the operator/technician may be allowed to select areas of interests of the spring (e.g., joints/moving elements/lines, etc.) in order to save computer resources and monitor the defined these segments only.

According to some embodiments, a processor may be executable, based at least on signals received from the at least one optical sensor, to monitor a trajectory and/or speed of movement of reference points (for example, predetermined reference points) on the spring and/or on an object attached thereto. The integrity and function of the mechanism, and optionally in an associated element, may be determined by the processor by comparing the monitored trajectory and/or speed of each of the reference points to pre-obtained (or pre-calculated) trajectory curve and/or speed of each of such reference points in a fully functional spring and/or object attached thereto. For example, in accordance with some embodiments, if one (or more) of the reference points may deviate from a predetermined trajectory curve a malfunction of the spring and/or object attached thereto may be determined. Additionally, and/or alternatively, maintenance may be recommended. Additionally, and/or alternatively, time until failure may be calculated and/or indicated.

According to some embodiments, the integrity and/or function of the spring and/or object attached thereto may be determined in real time. According to some embodiments, the integrity and/or function of the spring and/or object attached thereto, may be determined in real time from a remote location.

According to some embodiments, the method for determining the integrity and proper function of a spring and/or object attached thereto, may include, utilizing a processor:
defining one or more reference points on at least one moving part of the spring;
for each reference point, assigning a correct/normal trajectory and/or a correct/normal speed,
during operation of the mechanism, monitoring a trajectory and/or a speed of each of the reference points,
determining whether each of the monitored reference points moves along the respective assigned trajectory curve and/or moves at the assigned speed (or within margins/ranges defined for the assigned trajectory curve and/or speed of each reference point), and
if the trajectory and/or speed of at least one of the reference points deviates from the respective assigned (correct/normal) trajectory curve and/or speed or (predetermined) margins/ranges thereof:
providing an indication of suspected malfunction/failure/damage/fault of the mechanism, and/or
providing an indication of a predicted malfunction/failure/damage/fault of the mechanism.

According to some embodiments, the method may further include alerting a user of a suspected and/or predicted malfunction/failure/damage/fault of the mechanism.

According to some embodiments, the assigned (correct/normal) trajectory curve and/or speed of the reference points may be determined using the one or more optical sensors (e.g., cameras) of the system.

According to some embodiments, the assigned (correct/normal) trajectory curve and/or speed of the reference points may be determined by analyzing multiple images/video clips of a spring and/or object attached thereto (e.g., the total expansion and/or contraction of the spring, the distance between adjacent coils of the spring as it expands and/or contracts (spring pitch), deformation of the spring, angle between spring ends, etc.), and determining the “allowed” ranges/margins of trajectory curve and/or speed of each reference point that may still be defined as “normal”.

According to some embodiments, the assigned (correct/normal) trajectory curves and/or speed of the reference points may be determined by analyzing multiple images/video clips/data obtained from failed mechanisms (e.g., failed spring or components thereof) and obtaining trajectory curves and/or speed values that may be typical to failure.

According to some embodiments, a rate of deviation of the reference points from their respective assigned (correct/normal) trajectory curves and/or speed may be determined and utilized to predict a timeline to failure.

According to some embodiments, there is further provided herein a system for determining the degree of extension and/or contraction (e.g., the total expansion and/or contraction of the spring, the distance between adjacent coils of the spring as it expands and/or contracts (spring pitch), etc.) of a spring. Optionally, a change in the spring's ability to extend and/or contract may be indicative of a defect within the spring and/or mechanism.

According to some embodiments, there is further provided herein a system for determining the degree of deformation of the spring (e.g., rotation, overstretching, failure to return to original shape after contraction and/or expansion, movement of an end, etc.). Optionally, deformation of a spring may be indicative of a defect of the spring and/or mechanism.

According to some embodiments, the system includes at least one optical sensor, such as a camera, configured to be fixed on, in vicinity of, or within the mechanism, with a field of view encompassing at least a segment of the spring, and at least one processor in communication with the optical sensor.

According to some embodiments, the processor(s) may be executable to receive signals from the at least one optical sensor (such as images from the camera), to detect at least two markings (real or virtual) on at least two parts of the spring and/or object attached thereto, and to determine the degree of extension and/or contraction based on the relative positions of the two markings. According to some embodiments, the markings may be a line, symbol, or any other sign such as but not limited to, arrow(s) triangles etc. The markings may be for example, two lines, and the relative position of the two lines indicative of the degree of extension and/or contraction may be parallel convergence of the two lines. According to some embodiments, the markings may be in a configuration of Nonius or vernier scale so facilitate calculation of the level of accuracy (angular and/or linear) of the degree of extension and/or contraction. According to some embodiments, the processor may further be configured to provide an indication of the degree of extension and/or contraction of the spring and/or object attached thereto.

According to some embodiments, the processor(s) may be executable to receive signals from the at least one optical sensor (such as images from the camera), to detect at least two markings (real or virtual) on at least two parts of the spring and/or object attached thereto, and to determine the degree of distortion of the spring based on a relative position of the two markings. According to some embodiments, the markings may be a line, symbol, or any other sign such as but not limited to, arrow(s) triangles etc. The markings may be for example, two lines, and the relative position of the two lines indicative of the degree of deformation may be a shift in two parallel lines. According to some embodiments, the at least two markings may be stickers that may be attached to different elements of the spring and/or object attached thereto.

According to some embodiments, the at least two markings may be existing signs, such as defects, natural lines, or border lines on the spring and/or object attached thereto, that an algorithm applied by the system automatically identifies and selects, or that the operator selects, for example, through the technician's application.

According to some embodiments, the markings may be in a configuration of Nonius or vernier scale so facilitate calculation of the level of accuracy (angular and/or linear) of the degree of deformation. According to some embodiments, the processor may further be configured to provide an indication of the degree of deformation of the spring and/or object attached thereto.

According to an eighth aspect of some embodiments of the present invention there is provided a method for determining the degree of extension and/or contraction and/or deformation of the spring and/or object attached thereto. The method includes, utilizing at least one processor for:
receiving signals from the at least one optical sensor (such as images from the camera),
detecting at least two markings, e.g., lines, (real or virtual) on at least two parts of the spring,
determining the degree of extension and/or contraction and/or deformation based on a relative position between the at least two markings, e.g., lines, for example, parallel convergence thereof.

The method may further be configured to provide an indication of the degree of extension and/or contraction and/or deformation of the spring and/or object attached thereto.

In the context of the instant aspect of some embodiments of the present invention, a spring may comprise a coil, an elasticated component, mechanical spring, pneumatic system, hydraulic system, or combinations thereof. For example, shock absorber, Stockbridge damper, tuned mass damper, dashpot, hydrospring, oil damper, seismic damper, harmonic absorber, etc. Optionally, the spring may be linear and/or non-linear. For example, spring may be used in a variety of industries (e.g., automotive industry, medical industry, robotics industry, aerospace industry, energy industry, consumer industry, etc.) in products as diverse as landing gear, actuators, mechanical pencils, tuned mass dampers in bridges, wind turbines or skyscrapers, lawn mowers, cranes, etc.

In the context of the instant aspect of some embodiments of the present invention, a “damper” is defined herein as an object or system used to reduce and/or to neutralize oscillations and/or vibrations.

A “segment” is defined herein as at least one coil of the spring, an end of the spring, a base of the spring, an object attached to the spring, or combination thereof. Structures, such as high-rise buildings or skyscrapers, bridges, stadiums, wind turbines, high tension cables, etc., use springs such as dampers to reduce oscillations and/or vibrations (e.g., wind induced oscillations, traffic induced oscillations (e.g., from vehicles, trains, pedestrians etc.), mining or drilling (e.g., drilling for water, oil, underground tunnels, construction, etc.), hurricanes, tornadoes, monsoons, earthquakes, earth tremors, landslides, mudslides, expansion and/or contraction due to temperature extremes, etc.) therefore, maintaining and monitoring the spring is of critical importance.

Additionally, machines such as vehicles (e.g., cars, trucks, scooters, bicycles, etc.), aircraft (e.g., airplanes, helicopters, unmanned vehicles, spacecraft, etc.), watercraft (e.g., ships, boats, submarines, hovercraft, diving bells, cages, etc.), industrial robots (e.g., used on production lines such as to screw, paint, attach, weld, seal, carry, hold, etc.), may require springs. Damage to a spring may not always be obvious from external observation or by inspection with the human eye. Down time due to replacement of parts is costly, and accidents caused by mechanical failure is costly both in terms of down time, repairing damage caused and possibly even in human resources due to death and/or injury. Additionally, sometimes a part may be replaced even though there is no mechanical need to replace the component but because the maintenance schedule requires replacement of the component. This is costly and wasteful. Therefore, maintaining and monitoring such a spring is of critical importance.

There is thus provided herein, in accordance with additional and/or alternative embodiments, a system for monitoring/determining/predicting failure in a mechanism including a spring. The system includes at least one optical sensor, such as a camera, configured to be fixed on, in vicinity of, or within the mechanism, with a field of view encompassing at least a segment of the spring, and at least one processor in communication with the optical sensor. According to some embodiments the system is configured to determine the degree of contraction and/or extension and/or deformation of a spring.

According to some embodiments, the processor(s) may be executable to receive signals from the at least one optical sensor, to measure the speed of contraction or expansion and/or deformation (for example, by measuring linear velocity of different objects and the angular velocity of one or more components), and, utilizing algorithmics to calculate the linear velocity and/or the angular velocity of the contraction and/or expansion and/or deformation and provide an indication of the linear velocity of the contraction and/or expansion and/or deformation.

According to additional and/or alternative embodiments, the processor(s) may be executable to receive signals from the at least one optical sensor (such as images from a camera within the spring and/or a camera outside the spring), to monitor distortions in the shape of the spring, degree of contraction or extension (e.g., by measuring the degree of contraction directly or by measuring the distance between the spring ends) to estimate the intensity and/or direction of a parameter related to a force exerted on the object connected to the spring. Additionally, and/or alternatively, a spring may be non-linear (that is, it does not obey Hooke's Law) or linear (that is, it obeys Hooke's Law). Hooke's Law, and non-linear variations thereof, may allow the force exerted on the spring at any given moment to be estimated, and/or the position, trajectory, acceleration, or combination therefor of the component connected to the spring to be calculated.

For example, a change in the spring's dimensions such as mainly at the change in the distance between the wires (spring pitch) may indicate a change in the force applied on the spring. Optionally, the rate of change and/or direction may indicate an oscillating system and/or may be used to analyze the forces applied to it. For example, in the specific case of a shock absorber, the spring pushes a piston including a liquid (such as oil, brake fluid, water, etc.), a change in spring pitch may indicate a leak from the piston.

According to a ninth aspect of some embodiments of the present invention there is provided, a system for monitoring potential changes in a mechanism comprising a spring, the system comprising:
at least one optical sensor configured to be fixed on, in vicinity of, or within the mechanism, with a field of view encompassing at least a segment of the spring, wherein the at least one optical sensor is configured to capture an image from within and/or from outside of the spring or a segment thereof;
at least one processor in communication with the at least one optical sensor, the processor being executable to:
receive signals from the at least one optical sensor, wherein the received signal is selected from at least one image, a portion of an image, a set of images, video clip or video frame;
   identify at least one change in the received signal;
   for an identified change in the received signal, apply the at least one identified change to an image analysis algorithm configured to estimate at least one parameter related to a force exerted on the spring and/or object attached thereto; and
calculate the position, velocity, trajectory, acceleration, stability, or combination thereof of the object connected to the spring or a segment thereof.

According to some embodiments, for an identified change in the received signal, at least one identified change may be applied to an image analysis algorithm configured to analyze the identified change in the received signal and may classify whether the identified change in the received signal may be associated with a mode of failure of the spring or object affected by and/or attached thereto, may thereby label the identified change as a fault, based, at least in part, on the data associated with characteristics of at least one mode of failure of the spring or a segment thereof, and for an identified change classified as being associated with a mode of failure, may output a signal indicative of the identified change associated with the mode of failure.

According to some embodiments, the segment may include at least a portion of one coil of the spring, an end of the spring, a base of the spring, an object attached to the spring, or combination thereof. According to some embodiments, a change may be a change the springs' position, spring pitch, contraction, expansion or a combination thereof. According to some embodiments, a change may be a distortion in the shape of the spring. According to some embodiments, identifying at least one change in the signals may comprise identifying a change in the rate of change in the signals.

According to some embodiments, the algorithm takes into account at least one physical parameter or environmental parameter or a combination thereof. Optionally, the at least one physical parameter may include wire diameter, coil pitch, linear or non-linear spring, coil inner or outer diameter, spring length, spring stiffness, spring material, spring ends, composition of the spring, location of a spring, shape of an object to which a spring may be attached, mass of an object to which a spring may be attached, damping coefficient, frequency of oscillation of a spring or object affected by and/or attached thereto, etc. or any combination thereof. Optionally, the at least one environmental parameter may include wind speed, wind direction, duration of the wind, frequency of motion, velocity of motion, seismic activity, temperature, season or time of the year, pressure, time of day, hours of operation, duration of operation, an identified user of the spring and/or object attached thereto, GPS location, mode of operation, etc. or any combination thereof. Optionally, the algorithm may retrieve data on at least one physical parameter or environmental parameter from a database. Optionally, the database may be an online database, such as a mapping database, weather database, calendar, etc.

According to some embodiments, for an identified fault, at least one model of a trend in the identified fault may be generated. Optionally, the trend may comprise a rate of change in the fault. Optionally, calculating a correlation of the rate of change of the fault with one or more environmental parameters.

According to some embodiments, a user may be alerted to a predicted failure based, at least in part, on the generated model. Optionally, alerting the user of a predicted failure may comprise any one or more of a time (or range of times) of a predicted failure, a usage time of the spring and/or object attached thereto and characteristics of the mode of failure, or any combination thereof. Optionally, a prediction of when the identified fault may likely lead to failure in the spring or object affected by and/or attached thereto, may be based, at least in part, on the generated model and may be output. Optionally, predicting when a failure may likely occur in the spring or object affected by and/or attached thereto may be based, at least in part, on predicted future environmental parameters.

According to some embodiments, the mode of failure may comprise at least one of a change in spring pitch, change in expansion, change in contraction, a change in dimension, distortion of a dimension, a change in position, change in coil pitch, change in coil inner or outer diameter, a change in color, change in size, a change in appearance, a fracture, a structural damage, a crack, crack size, crack location, crack propagation, a specified pressure applied to the spring or object affected by and/or attached thereto, a change in the movement of one component in relation to another component, an amount of leakage, a rate of leakage, change in rate of leakage, amount of accumulated liquid, a change in the amount of accumulated liquid size of formed bubbles, drops, puddles, jets, or any combination thereof.

According to some embodiments, if the identified change may not be classified as being associated with a mode of failure, data associated with the identified change may be storied and/or used for further investigation, wherein the further investigation may comprise at least one of adding a mode of failure, updating the algorithm configured to identify the change, and training the algorithm to ignore the identified change in the future, thereby improving the algorithm configured to identify the change.

According to some embodiments, obtaining data associated with characteristics of at least one mode of failure of the spring or object affected by and/or attached thereto may comprise data associated with a location of the mode of failure on the spring or object affected by and/or attached thereto and/or a specific type of mode of failure. Optionally, data received from a user may be inputted. Optionally, the data from a database may be automatically retrieved, and may be based, at least in part, on the received signals from at least one optical sensor. Optionally, a previously unknown failure mode may be identified by applying the received signals to a spring learning algorithm configured to determine a mode of failure of the spring or object affected by and/or attached thereto. Optionally, identifying the at least one change in the signals may comprise analyzing raw data of the received signals.

According to some embodiments, identifying the at least one change in the received signal may comprise analyzing dynamic movement of the spring or object affected by and/or attached thereto, wherein the dynamic movement comprising any one or more of non-linear movement, linear movement, rotational movement, vertical movement, periodic (repetitive) movement, and oscillating movement.

According to some embodiments, identifying the at least one change in the received signal may comprise analyzing distortion, damage, defect, crack size/length, crack growth rate, crack propagation, fracture, structural damage, defect diameter, cut, warping, inflation, deformation, abrasion, wear, corrosion, oxidation, smoke, fluid flow rate, drop size, fluid volume, rate of accumulation of liquid, change in texture, change in color/shade, a change in dimension, a change in position, a change in color, a change in texture, change in size, a change in appearance, or any combination thereof.

According to some embodiments, identifying the at least one change in the received signal may comprise analyzing any one or more of the total intensity, variance intensity, spackle detection, line segment detection, line segment registration, edge segment curvature estimation, homography estimation, specific object identification, object detection, semantic segmentation, background model, change detection, detection over optical flow, or reflection detection, flame detection, or any combination thereof.

According to some embodiments, data associated with an optimal location for placement of the optical sensor, from which potential modes of failure can be detected may be output. Optionally, at least one light source may be configured to illuminate the spring or object affected by and/or attached thereto. Optionally, the illumination may be based on a light bulb, light-emitting diode (LED), laser, a fiber light source, fiber optic cable, and the like. Optionally, classifying whether the identified change in the signals may be associated with a mode of failure of the spring or object affected by and/or attached thereto may be based, at least in part, on any one or more of the placement(s) of the at least one light source, the duration of illumination, the wavelength, the intensity, and the frequency of illumination.

According to some embodiments, a system may be configured to monitor a mode of failure of a spring or object affected by and/or attached thereto, and may comprise: identifying at least one segment comprising boundaries of a perimeter of the visible portion of the spring, within the received signals, such that identifying the at least one change in the received signals comprises identifying a change or rate of change of the shape or ability to expand or contract (spring pitch) of the at least one segment;
wherein the mode of failure comprises distortion or weakening of the spring, and wherein generating at least one model of a trend in the identified change comprises modeling a trend in a parameter of the segment, thereby monitoring whether the spring may be defective. Optionally, the segment may be at least one coil of the spring, an end of the spring, a base of the spring, an object attached to the spring, or combination thereof.

According to a tenth aspect of some embodiments of the present invention there is provided a computer implemented method for monitoring a spring or object affected by and/or attached thereto may comprise:
receiving signals from at least one optical sensor configured to be fixed on, in the vicinity of, or within the mechanism, with a field of view encompassing at least a segment of the spring;
obtaining data associated with characteristics of at least one mode of failure of the spring or object affected by and/or attached thereto;
identifying at least one change in the received signals;
for an identified change in the received signals, applying the at least one identified change to an algorithm configured to analyze the identified change in the received signals and to classify whether the identified change in the received signals may be associated with a mode of failure of the spring or affected by and/or object attached thereto based, at least in part, on the obtained data; and
for an identified change may be classified as being associated with a mode of failure, outputting a signal indicative of the identified change associated with the mode of failure.

According to an eleventh aspect of some embodiments of the present invention there is provided a system for monitoring potential a damper may comprise:
at least one optical sensor configured to be fixed on or within or in the vicinity of the damper, wherein an optical sensor captures an image from within and/or from outside of the damper;
at least one processor in communication with the at least one optical sensor, the processor being executable to:
receive signals from the at least one optical sensor, wherein the received signal maybe selected from at least one image, a portion of an image, a set of images, video clip or video frame;
identify at least one change in the received signal;
for an identified change in the received signal, apply the at least one identified change to an image analysis algorithm configured to analyze the identified change in the received signal, estimate at least one parameter associated with a force exerted on the damper, and calculate the position, velocity, trajectory, acceleration, stability, or combination thereof of an object connected to the damper based on the identified change;
and optionally:
classify whether the identified change in the received signal may be associated with a mode of failure of the damper, thereby labeling the identified change as a fault, based, at least in part, on the data associated with characteristics of at least one mode of failure of the spring or a segment thereof; and
for an identified change classified as being associated with a mode of failure, outputting a signal indicative of the identified change associated with the mode of failure.

According to some embodiments, the processor may be executable to receive signals from the at least one optical sensor, obtain data associated with characteristics of at least one mode of failure of the mechanism and/or spring and/or an associated element (e.g., a change in the ability to extend and/or contract may be indicative of a defect within the spring), identify at least one change in the received signals, for an identified change in the received signals optionally, apply the at least one identified change to an algorithm configured to analyze the identified change in the received signals and to classify whether the identified change in the received signals may be associated with a mode of failure of the mechanism and/or associated element, labeling the identified change as a fault, based, at least in part, on the obtained data and for an identified change classified as being associated with a mode of failure, outputting a signal indicative of the labeled identified change associated with the mode of failure.

According to some embodiments, for an identified fault, the processor(s) may generate at least one model of a trend in the identified fault, wherein the trend may include a rate of change in the fault.

According to some embodiments, the system may be configured for smart maintenance of the mechanism and/or spring and/or an associated element, by using one or more algorithms configured to detect a change, identify a fault, and determine whether the fault may develop into a failure of the spring and/or object attached thereto.

Optionally, the system and method may enable visualization of inaccessible areas which require high efforts to be examined/maintained, by positioning the one or more optical sensors, on, in the vicinity of, within the damper, with a field of view encompassing at least a segment of the spring that may not be visually monitored otherwise.

Optionally, the system and method may reduce the time and cost due to a failed product (e.g., spring and/or damper) and/or reduce the cost of process times that may render the machines and/or structure in a disabled state during the replacement of the failed component. Moreover, the system and method may minimize the cost of unnecessary maintenance, and the cost of unnecessary part replacement, which may be done automatically when a spring and/or object attached thereto may be replaced regularly due regular protocol maintenance of the spring and/or object attached thereto.

Optionally, the system may enable trend identification and calculation, thereby analyzing the trends in the fault development within the spring and/or object attached thereto, and thus enabling the prediction of failure even before there may be a change in normal behavior or operation of the spring and/or object attached thereto.

According to a twelfth aspect of some embodiments of the present invention there is provided a system for monitoring potential failure in a mechanism, the system including:
at least one optical sensor configured to be fixed on or within or in vicinity of the mechanism, with a field of view encompassing at least a segment of the spring and/or object attached thereto,
at least one processor in communication with the at least one optical sensor,
the processor(s) being executable to:
receive signals from the at least one optical sensor,
obtain data associated with characteristics of at least one mode of failure of the mechanism and/or object attached thereto,
identify at least one change in the received signal, for an identified change in the received signal,
apply the at least one identified change to an algorithm configured to analyze the identified change in the received signal,
classify whether the identified change in the received signal may be associated with a mode of failure of the mechanism,
label the identified change as a fault, based, at least in part, on the obtained data, and
for an identified change may be classified as being associated with a mode of failure, output a signal indicative of the identified change associated with the mode of failure.

According to a thirteenth aspect of some embodiments of the present invention there is provided a computer implemented method for monitoring a mechanism, the method including:
receiving signals from at least one optical sensor fixed on or within or in vicinity of the mechanism, with a field of view encompassing at least a segment of the spring and/or object attached thereto,
obtaining data associated with characteristics of at least one mode of failure of the mechanism,
identifying at least one change in the received signal, for an identified change in the received signals, applying the at least one identified change to an algorithm configured to analyze the identified change in the received signal, and
classifying whether the identified change in the received signal may be associated with a mode of failure of the mechanism and/or associated element based, at least in part, on the obtained data, and
outputting a signal indicative of the identified change associated with the mode of failure for an identified change classified as being associated with a mode of failure.

According to some embodiments, for an identified fault, the method and/or system includes generating at least one model of a trend in the identified fault.

According to some embodiments, the trend includes a rate of change in the fault.

According to some embodiments, generating the at least one model of trend in the identified fault includes calculating a correlation of the rate of change of the fault with one or more environmental parameters.

According to some embodiments, for an identified fault, the method and/or system includes alerting a user of a predicted failure based, at least in part, on the generated model.

According to some embodiments, alerting the user of a predicted failure includes any one or more of a time (or range of times) of a predicted failure, a usage time of the spring and/or object attached thereto and characteristics of the mode of failure, or any combination thereof.

According to some embodiments, identifying at least one change in the signals includes identifying a change in the rate of change in the signals.

According to some embodiments, the one or more environmental parameters include existing knowledge about the monitored spring and/or object attached thereto and/or or a calibration process to define one or more parameters of the spring and/or object attached thereto.

According to some embodiments, the one or more environmental parameters include at least one of temperature, season or time of the year, pressure, time of day, hours of operation of the spring and/or object attached thereto, duration of operation of the spring and/or object attached thereto, an identified user of the spring and/or object attached thereto, GPS location, mode of operation of the spring and/or object attached thereto, or any combination thereof.

According to some embodiments, processor and/or algorithm may take into account one or more environmental parameters include at least one of temperature, season or time of the year, pressure, time of day, hours of operation of the structure and/or machine and/or component thereof, duration of operation of the structure (e.g., age of the structure, amount of foot and motor traffic in and around the structure depending on the time of day, etc.) and/or machine (e.g., cycle time, run time, down time, etc.) and/or component thereof, an identified user of the structure and/or machine and/or component thereof, GPS location, mode of operation of the structure (e.g., residential, commercial, industrial, etc.) and/or machine (e.g., continuous, periodic, etc.) and/or component thereof, and/or any combination thereof. Optionally, the system may retrieve data on one or more environmental parameters from an online database, such as a mapping database, weather database, calendar, etc. to be included in the analysis.

According to some embodiments, for an identified fault, the method and/or system includes outputting a prediction of when the identified fault may likely lead to failure in the spring and/or object attached thereto, based, at least in part, on the generated model.

According to some embodiments, predicting when a failure may be likely to occur in the spring and/or object attached thereto may be based, at least in part, on predicted future environmental parameters.

According to some embodiments, the mode of failure includes at least one of a change in dimension, distortion of one or more dimensions, a change in position, a change in color, a change in texture, change in size, a change in appearance, a fracture, a structural damage, a crack, crack size, critical crack size, crack location, crack propagation, a specified pressure applied to the spring and/or object attached thereto, a change in the movement of one component in relation to another component, or any combination thereof.

According to some embodiments, for an identified fault, the method and/or system includes, if the identified change may not be classified as being associated with a mode of failure, storing and/or using data associated with the identified change for further investigation, wherein the further investigation includes at least one of adding a mode of failure, updating the algorithm configured to identify the change, and training the algorithm to ignore the identified change in the future, thereby improving the algorithm configured to identify the change.

According to some embodiments, obtaining data associated with characteristics of at least one mode of failure of the spring and/or object attached thereto includes data associated with a location of a fault or failure on the spring and/or mechanism thereto and/or a specific type of mode of failure.

According to some embodiments, obtaining data associated with characteristics of at least one mode of failure of the spring and/or object attached thereto includes receiving inputted data from a user.

According to some embodiments, for an identified fault, the method and/or system includes analyzing the received signal and wherein obtaining data associated with characteristics of at least one mode of failure of the mechanism includes automatically retrieving the data from a database, based, at least in part, on the received signals from at least one optical sensor. Optionally, the system may retrieve data from an online database, such as a mapping database, weather database, calendar, traffic database, etc. to be included in the analysis.

According to some embodiments, obtaining data associated with characteristics of at least one mode of failure of the mechanism includes identifying a previously unknown failure mode by applying the received signals to a machine learning algorithm configured to determine a mode of failure.

According to some embodiments, identifying the at least one change in the signals includes analyzing raw data of the received signals.

According to some embodiments, the at least one signal includes at least one image, a portion of an image, a set of images, video clip or video frame.

According to some embodiments, identifying the at least one change in the signals includes analyzing dynamic movement of the spring and/or object attached thereto, wherein the dynamic movement including any one or more of linear movement, non-linear movement, vertical movement, rotational movement, periodic (repetitive) movement, and oscillating movement.

According to some embodiments, identifying the at least one change in the signals includes analyzing damage, distortion, defect, crack size/length, crack growth rate, crack propagation, fracture, structural damage, defect diameter, cut, warping, inflation, deformation, abrasion, wear, corrosion, oxidation, sparks, smoke, fluid flow rate, drop size, fluid volume, rate of accumulation of liquid, change in texture, change in color/shade, size of formed bubbles, a change in dimension, a change in position, a change in color, a change in texture, change in size, a change in appearance, or any combination thereof.

According to some embodiments, for an identified fault, the method and/or system includes identifying at least one segment within the received signals, to be monitored, and wherein the at least one change in the signals may be a change within the at least one segment, e.g., a particular area of a spring such as the distance between two coils, angle between spring ends, an attachment hook at an end of the spring, an area that appears to be thinner, different color, different texture, scratched, cracked, etc. According to some embodiments, the at least one segment may be automatically identified. According to some embodiments, the at least one segment may be manually identified by a user.

According to some embodiments, for an identified fault, the method and/or system includes monitoring the at least one segment and detecting a change in the shape and/or color of the at least one segment, size of the at least one segment, distortion of the at least one segment, rate of occurrence of the at least one segment in the received signals, or any combination thereof.

According to some embodiments, the at least one segment includes the boundaries of a surface defect.

According to some embodiments, the at least one segment includes the boundaries of a specific element of the spring and/or object attached thereto, and further including identifying a geometrical shape of the at least one segment as the specific element of the spring and/or object attached thereto.

According to some embodiments, the specific element includes any one or more of a coil, screw, spring, hook, shaft, a connector, a bolt, one or more vehicles components, motors, gear box, actuator, turbine components, cables, belts, wires, fasteners, cylinders, blades, nuts, one or more flexible, semi-rigid, or rigid pipes/tubes, and any combination thereof. Each option is a separate embodiment.

According to some embodiments, the specific element includes a shock absorber.

According to some embodiments, the specific element includes a tuned mass damper.

According to some embodiments, identifying the geometrical shape includes analyzing any one or more of the total intensity, variance intensity, spackle detection, line segment detection, line segment registration, edge segment curvature estimation, homography estimation, specific object identification, object detection, semantic segmentation, background model, change detection, detection over optical flow, or reflection detection, flame detection, or any combination thereof.

According to some embodiments, for an identified fault, the method and/or system includes outputting data associated with an optimal location for placement of the optical sensor, from which potential modes of failure can be detected.

According to some embodiments, for an identified fault, the method and/or system includes at least one light source configured to illuminate the spring, and wherein classifying whether the identified change in the signals may be associated with a mode of failure of the mechanism may be based, at least in part, on any one or more of the placement(s) of the at least one light source, the duration of illumination, the wavelength, the intensity, the direction of illumination, and the frequency of illumination.

According to some embodiments, the system may be configured to monitor a mode of failure of a mechanism, and further including: identifying at least one segment including boundaries of a perimeter of a surface defect within the received signals, such that identifying the at least one change in the received signals includes identifying a change or rate of change of the shape and/or propagation of the at least one segment, and wherein the mode of failure includes a distortion of the spring and/or change in the ability of the spring to expand and/or contract (spring pitch), and wherein generating at least one model of a trend in the identified change includes modeling a trend in a specific mode of operation, thereby monitoring the spring.

According to some embodiments, the at least one segment may be automatically identified. According to some embodiments, the at least one segment may be manually identified by a user.

According to some embodiments, the specific mode of operation of the spring includes any one or more of a pressure applied to the spring, relaxation of a pressure on a spring, a frequency or rotation of operation of the spring, a speed of rotation, a speed of expansion and/or contraction of the spring, a duration of operation, lubricant presence, or any combination thereof.

Embodiments of the invention may include combination of the first, second, third, fourth, fifth, sixth, seventh, eighth, ninth, tenth, eleventh, twelfth and thirteenth aspects of the invention disclosed herein.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment, an entirely software embodiment (including firmware, resident software, micro code, etc.) or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or and computer program products according to embodiments of the present disclosure. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the invention, unless otherwise indicated. In the drawings like reference numerals are used to indicate corresponding parts.

In block diagrams and flowcharts, optional elements/components and optional stages may be included within dashed boxes.

In the figures:

FIGS. 1A-1C are simplified illustrations of three types of springs respectively;

FIGS. 2A-2B are simplified diagrams of an actuator, according to an exemplary embodiment of the invention;

FIGS. 3A-3B are simplified diagrams of a weight support mechanism, according to an exemplary embodiment of the invention;

FIGS. 4A-5 are simplified block diagrams of a system for monitoring a mechanism, in accordance with respective embodiments of the invention;

FIGS. 6A-6B are images of exemplary dampers which may be monitored in accordance with some embodiments of the present invention;

FIG. 7A is a simplified cross section of an oil reservoir damper with a spring, in accordance with exemplary embodiments of the present invention;

FIG. 7B is an enlarged view of a portion of FIG. 7A, illustrating the field of view of a camera;

FIGS. 8-9 are simplified flowcharts of methods for monitoring a mechanism, according to respective embodiments of the invention;

FIG. 10 is a simplified schematic illustration of a system for monitoring a mechanism in accordance with some exemplary embodiments of the invention;

FIG. 11 is a simplified flowchart of a computer implemented method for monitoring a mechanism, in accordance with some exemplary embodiments of the invention;

FIG. 12 is a simplified schematic block diagram of a method for monitoring a mechanism, in accordance with some exemplary embodiments of the invention; and

FIG. 13 is a schematic block diagram of a system for monitoring a mechanism, in accordance with some exemplary embodiments of the invention.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

The present disclosure, in some embodiments, thereof, relates to monitoring the health of a mechanism, and, more particularly, but not exclusively, to monitoring a mechanism comprising a spring.

Springs are used in a wide variety of applications, such as suspension systems for vehicles, manufacturing machinery, shock and vibration absorbers, medical machinery, hinges and many more.

Some embodiments of the invention presented herein analyze image data of a spring (also denoted herein spring image data) in order to monitor a mechanism which includes the spring. The analysis may provide information about the health of the mechanism itself and/or of elements associated with the mechanism and/or the conditions in which the mechanism is operating. The analysis may detect immediate problems and/or predict future problems in the mechanism and/or associated elements.

The image data is provided by one or more optical sensors positioned with a view of the spring or a section thereof. In the case of multiple optical sensors, the optical sensors may view different sections of the spring and/or view the spring from different angles.

Optionally, the processing circuitry controls the optical sensor(s) and light sources(s), for example in order to synchronize image data capture during a strobe light pulse. Using a strobe light pulse enables capturing a clear image of the spring even when it is in rapid motion.

As used herein, according to some embodiments of the invention, the term “mechanism” mean a system of objects working together to perform a function. The term mechanism encompasses any type of system which utilizes a spring, it also includes but is not limiting to mechanisms which contain a limited number of internal components (and typically perform a limited function). Examples of mechanisms include but are not limited to mechanical devices (such as actuators, dampers, spring locks), machines, vehicles (such as cars, trucks, motorcycles, bicycles, scooters and trains), aircraft (e.g. drones, airplanes and helicopters), suspension systems, manufacturing facilities, structural elements (such as high tension cables, bridges, buildings and stadiums), wind turbines and many others.

As used herein, according to some embodiments of the invention, the term “monitoring a mechanism” means monitoring any type of mechanism which utilizes a spring.

As used herein, according to some embodiments of the invention, the term “spring” means an elastic element which deflects under the action of the load and returns to its original shape when the load is removed. Optionally, a spring is a mechanical component which is capable of storing potential energy through deformation, compression or extension and releasing it when subject to an external force. Springs can be made of various materials, including but not limited to metal, rubber or composite materials. Examples of springs can be compression springs, extension springs, torsion springs, coil springs, constant force springs, Belleville (disc) springs, leaf springs, conical spring washers, v-springs (wave springs) and gas springs. Springs are commonly used in mechanisms for support, absorb shocks, transmit forces, maintain equilibrium, or facilitate motion.

As used herein, according to some embodiments of the invention, the term “section of a spring” means any portion of the length and/or circumference of the spring. Examples include but are not limited to coil(s) of a spring (e.g. to monitor extension and compression of a helical spring), end(s) of a spring (e.g. to monitor angle in a torsion spring), spring leaf (e.g. to monitor deflection in a leaf spring) and so forth.

As used herein, according to some embodiments of the invention, the term “associated element” means any element whose performance and/or health is affected by the mechanism and/or the spring in the mechanism. Examples of such elements may include but are not limited to peripheral components connected to the mechanism (e.g. wires, cables, screws, connectors, object connected to a spring in the mechanism, etc.) or in the vicinity of the mechanism.

As used herein, according to some embodiments of the invention, the term “image data” means data that is based on images captured by one or more optical sensors. The image data may include the images themselves and/or the data obtained by processing the images (for example to format the images into a data format suitable for the processing circuitry, to adjust contrast and/or brightness in the images, compensate for optical sensor vibration, etc.).

As used herein, according to some embodiments of the invention, the term “optical sensor” mean a device which senses an optical signal and outputs an electronic signal (e.g. an image).

The principles, uses and implementations of the teachings herein may be better understood with reference to the accompanying description and figures. Upon perusal of the description and figures present herein, one skilled in the art will be able to implement the teachings herein without undue effort or experimentation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### I. Spring Properties

Spring properties and behavior may be significant when analyzing images of the spring, particularly when the mechanism is in operation (under known or unknown conditions). In some cases, the behavior of a spring is known at least in in part by its structure, material, method of manufacture, mechanism in which the spring is implemented and so forth. Knowledge of the spring may be based on manufacturer specifications, which generally include many details about the spring and its properties. Additional information may be obtained by testing and/or calibrating a specific spring or similar springs and/or a mechanism which the spring is a part of.

One type of spring is a compression spring which compresses when force is applied and returns to its original shape when the force is released. Another type of spring is an extension spring which extends when force is applied and returns to its original shape when the force is released. There are other types of springs, including torsion springs and constant force springs.

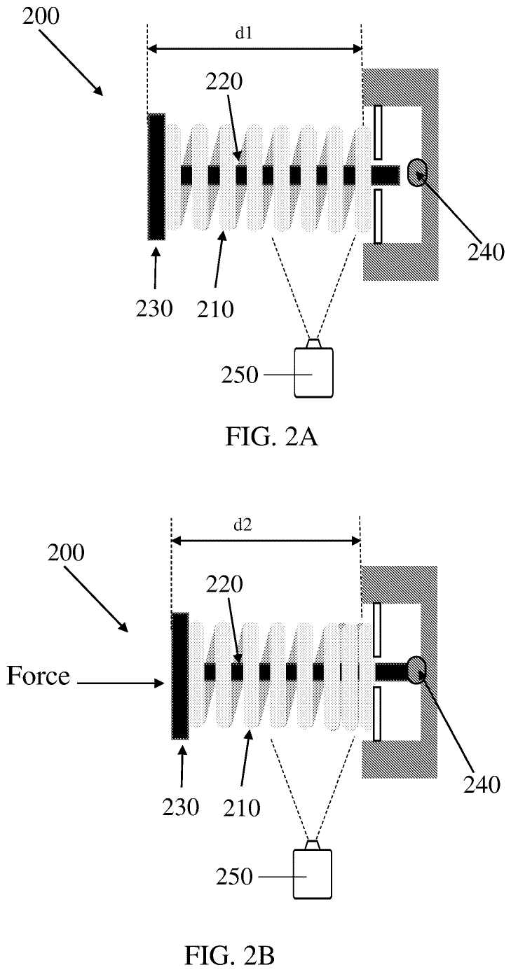

Springs may be linear or non-linear. Linear springs obey Hooke's law whereas non-linear springs do not. For example, FIG. 2A shows and linear spring whereas in FIG. 2B the spring behaves non-linearly (as only the coils at the end compress).

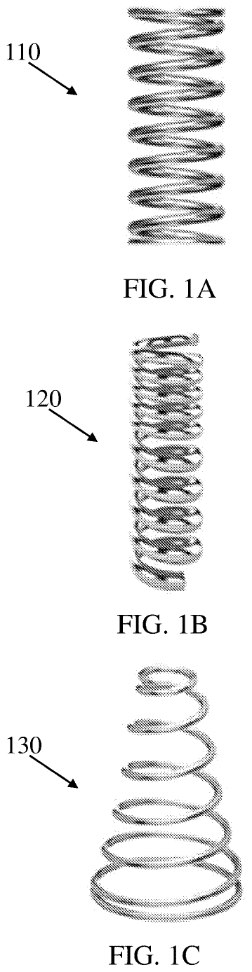

Reference is now made to FIGS. 1A-1C, which are simplified illustrations of three types of coil springs respectively. It is noted that the figures focus on types of coil springs for ease of reference. However, embodiments of the invention cover different types of springs such as torsion springs where the angle between the two spring ends is monitored or leaf springs where the layers of the springs are monitored.

FIG. 1A illustrates a helical linear spring 110. Typically, when not under force the windings are spaced evenly and have substantially the same shape. FIG. 1B illustrates a helical non-linear spring 120. Note that the windings have substantially the same shape as in FIG. 1A but are not spaced evenly. FIG. 1C illustrates a conical spring 130. The shape of the windings increases over the length of the spring.

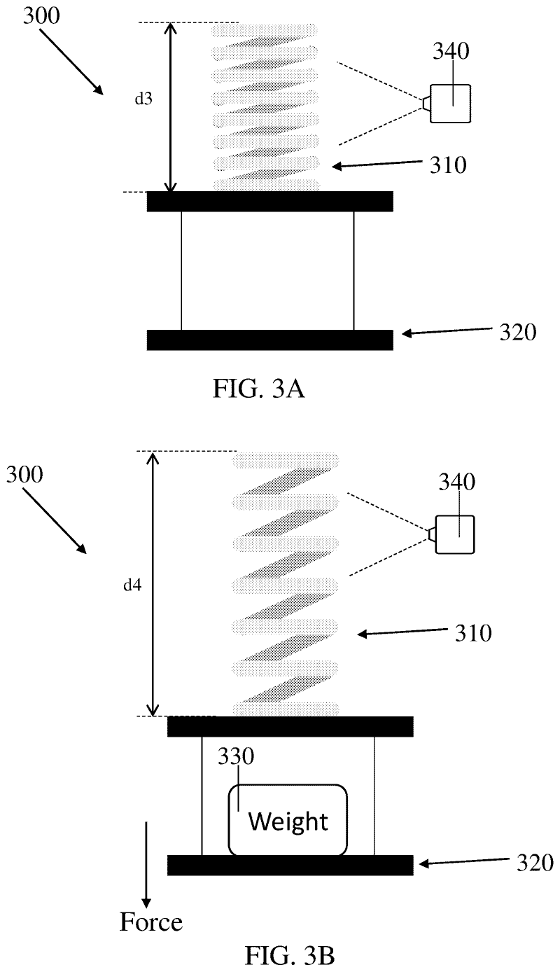

Springs may change their physical dimensions when a force is applied to them. Images showing these changes may provide information about many aspects of the mechanism, as illustrated by the simplified examples of FIGS. 2A-3B.

Reference is now made to FIGS. 2A-2B, which are simplified diagrams of an actuator, according to an exemplary embodiment of the invention. Actuator 200 includes a compression spring 210 with rod 220 running through it. In FIG. 2A no force is applied to plate 230, spring 210 is fully extended (length d1), and rod 220 does not touch contact 240. In FIG. 2B a force is applied to plate 230, causing the coils on the right portion of spring 210 to compress, reducing the length of spring 220 (length d2) and causing rod 220 to touch contact 240.

Optical sensor 250 captures images of spring 210 with a fixed field of view. In the embodiment shown, when spring 210 is fully extended (as in FIG. 2A) the field of view includes four, evenly spaced coils. When spring 210 is partially compressed (as in FIG. 2B), the field of view includes five coils with different spacings between them. An analysis of images captured in these two cases may provide information not only about the spring itself, but also about the operational state of the actuator (e.g. contact or no contact), the relative locations of other actuator components and an estimate of the force applied to plate 230. In some embodiments, monitoring the magnitude of the applied force and the time the force is applied is used to estimate wear of the mechanism and/or associated elements.

A similar analysis may be performed when the force is released, to determine if the spring returns to its original state before the force was applied. For example, a fault in actuator 200 may be suspected if spring 210 fails to return to its original length d1 and/or the coils remain unevenly spaced.

Reference is now made to FIGS. 3A-3B, which are simplified diagrams of a weight support mechanism, according to an exemplary embodiment of the invention. Mechanism 300 includes spring 310 which supports platform 320. In FIG. 3A no weight is placed on platform 320, the length of spring 310 is d3 and the coils are evenly spaced. In FIG. 3B, weight 330 is placed on platform 320, causing the spring 220 to extend to length d4. The coils are evenly spaced however their pitch has increased.

Optical sensor 340 captures images of spring 310 with a fixed field of view. In the embodiment shown, when no weight is present (as in FIG. 3A) the field of view includes four coils evenly spaced. When a weight is applied (as in FIG. 3B), the field of view includes two coils with a larger spacing between them. An analysis of images captured in these two cases may provide information not only about the spring itself, but also about the physical location of the platform and an estimate of the weight applied to platform 320. For example, if the coils are unevenly spaced when the weight is on platform 320, it may be suspected that something is impeding the motion of platform 320 so that spring 310 cannot extend properly. In another example, knowledge of the applied weight and the time period it was applied may be used to calculate wear of the mechanism, components of the mechanism and/or associated elements.

A similar analysis may be performed when the weight is removed, to determine if the mechanism returns to its original state before the weight was applied. For example, a fault in mechanism 300 may be suspected if spring 310 fails to return to its original length d3.

### II. Monitoring System

In some embodiments of the invention, the system for monitoring the mechanism (also denoted the monitoring system) includes processing circuitry in communication with one or more optical sensors. The processing circuitry inputs image data of at least one section of the spring from the optical sensor(s). The processing circuitry analyzes the image data and provides an indicator health of the mechanism (also denoted mechanism health) based on the analysis, as described in more detail below.

Some or all of the optical sensors may be part of the system. Alternately or additionally, some or all of the optical sensors may be external to the system.

Optionally, operation of the mechanism operation is controlled in real-time based on the information provided by the indicator(s).

As used herein, according to some embodiments of the invention, the terms “real-time” and “real-time control” mean within a time period short enough to enable a response while the machine in which the mechanism is still in operation. The duration of the time period is typically very short, and optionally is specified or otherwise determinable.

The maximum time period that is suitable for real-time control depends on the implementation. For example, a detected fault or failure in a landing gear may require aborting the landing within seconds whereas a detected fault or failure in a manufacturing machine may require shutting down production within a minute. Examples of real-time control include but are not limited to:
i. Less than 10 seconds from output of the indicator;
ii. Less than a minute from output of the indicator; and
iii. Less than the estimated time period until failure.

As used herein, according to some embodiments, the term “fault” may refer to an anomaly or undesired effect or process in the mechanism and/or spring and/or associated elements that may or may not develop into a failure. A fault may require follow-up, for example to analyze whether any components should be repaired or replaced.

According to some embodiments, the fault may include, among others, lack of alignment, improper response to an applied force or when a force is not applied, structural deformation, surface deformation, a crack, crack propagation, a defect, bending, wear, corrosion, leakage, a change in color, a change in appearance, change in pattern and the like, or any combination thereof.

As used herein, according to some embodiments of the invention, the term “failure” may refer to any problem that may cause the mechanism and/or associated elements to not operate as intended. In some cases a failure may disable mechanism and/or associated elements or even pose a danger to the associated element or user.

As used herein, according to some embodiments of the invention, the terms “failure mode” and “mode of failure” are to be widely construed to cover any manner in which a fault or failure may occur, such as structural deformation, surface deformation, a crack, crack propagation, a defect, bending, wear, corrosion, leakage, a change in color, a change in appearance, turbulence, bubbles in a liquid, and the like, or any combination thereof. It is appreciated that a mechanism may be subject to a plurality of failure modes, related to different characteristics or functionalities thereof.

Optionally, the minimum length of at least one of the sections imaged is based on the properties of the spring. Optionally, the minimum length of the at least one of the sections should be sufficient to provide indication of the exerted force on the spring.

In a first example the spring is a linear spring whose coils compress/decompress evenly, and the minimum length comprises at least two coils visible during either the open or compressed state. Optionally, a single coil may be sufficient for monitoring the spring behavior.

In a second example the spring is a non-linear spring. In a non-linear spring selecting the section of the spring for imaging and analysis may be performed as follows. First the critical regions or segments of the spring that exhibit different behaviors are identified. These areas may include regions of nonlinearity, discontinuities, and/or changes in stiffness. A respective threshold for the minimal section (or minimal number of coils) that should be imaged may be specified for each region. Different regions might require different thresholds to capture their unique characteristics accurately, but optionally at least two coils from each region should be visible during either the open or compressed state.

In some embodiments, the spring image data is used to determine the health of components of the mechanism and/or associated elements. In some embodiments, determining the health of the mechanism and/or associated elements means estimating the wear of the mechanism and/or associated elements based on the stresses placed on the mechanism and/or associated elements during operation (e.g. the previous day, week, month or since a previous time of evaluation).

As used herein, according to some embodiments of the invention, the terms “component of the mechanism” and “mechanism component” mean one of the objects forming the mechanism. Note that when the mechanism is complex, the mechanism component whose health is analyzed may be a separate subsystem than the subsystem which contains the spring. This is possible when the state of the spring has a direct and/or indirect effect on the other subsystem. For example, when the mechanism is an aircraft, the spring may be located in the suspension system whereas the analyzed component of the mechanism may be in the hydraulic system.

Embodiments of the monitoring system may be employed for many purposes including but not limited to:
1) Monitoring the health of the mechanism (e.g. damper, actuator, suspension system, building stabilization, machine, vehicle, aircraft, etc.);
2) Monitoring the functioning and/or health of an element associated with the mechanism;
3) Monitoring use and wear of the mechanism;
4) Monitoring the conditions in which the mechanism is operating;
5) Predicting potential failure of the mechanism;
6) Predicting potential failure of an associated element or peripheral component; and
7) Determining when maintenance is or will be required for the mechanism and/or associated element.

In some embodiments, at least some of the operational parameters, metrics and/or data points used to evaluate the health of an element are obtained from instructions and/or guidelines provided by a manufacturer of the spring, manufacturer of the mechanism, manufacturer and/or operator of the system, user etc.

As used herein, according to some embodiments, the term “health” of an element means the overall state, functionality, and condition of that specific element. It encompasses the evaluation of various operational parameters, metrics or data points that indicate the element's current status, performance and ability to operate as intended.

Mechanisms may include a single spring or multiple springs. For clarity, some non-limiting embodiments of the invention are described as monitoring a single spring in a mechanism. However embodiments of the present invention encompass mechanisms with multiple springs and mechanisms a with single spring.

When a mechanism includes multiple springs, image data may be captured for each spring individually and/or a single optical sensor may provide image data for multiple spring in its field of view. Optionally, the image data is analyzed for each spring individually and the health of the mechanism is evaluated based on the separate results for each spring. In additional or alternate embodiments, the image data for multiple springs is analyzed jointly to determine the health of the mechanism.

Optionally, at least one optical sensor is mounted within a housing covering at least some of the mechanism. The parts of the mechanism covered by the housing cannot be visually inspected from outside the mechanism. However the optical sensor within the housing is able to obtain image data of the covered portion and provide it to the processing circuitry. Further optionally, at least one light element is mounted within the housing and positioned to illuminate all or some of the field of view of the optical sensor within the housing.

In one example, the mechanism is a liquid spring which exhibits a spring-like behavior without including a coil spring inside. The spring-like behavior is achieved through the use of a fluid, which is contained within a chamber or container. When a force is applied to the liquid spring, the liquid compresses or expands. An optical sensor may be located in the chamber containing the liquid. Typically the liquid is silicone oil which is transparent. Thus the optical sensor in the chamber, or outside a transparent chamber, may capture image data of a spring that is otherwise completely inaccessible to visual inspection.

In a second example, the mechanism is a vehicle with a suspension system. The suspension system contain a damper and spring. The spring is in a separate chamber from the damper fluid. Images of the spring may be analyzed to determine the movement and functioning of the piston which causes the damper fluid flow. For example, large oscillations of the spring may indicate that the damper fluid has leaked. Knowledge of the motion of the damper in turn provides information about the health of the suspension system it is a part of. The health of the suspension system effects the health of the entire vehicle. Thus spring image data may be analyzed to evaluate the health of the vehicle.

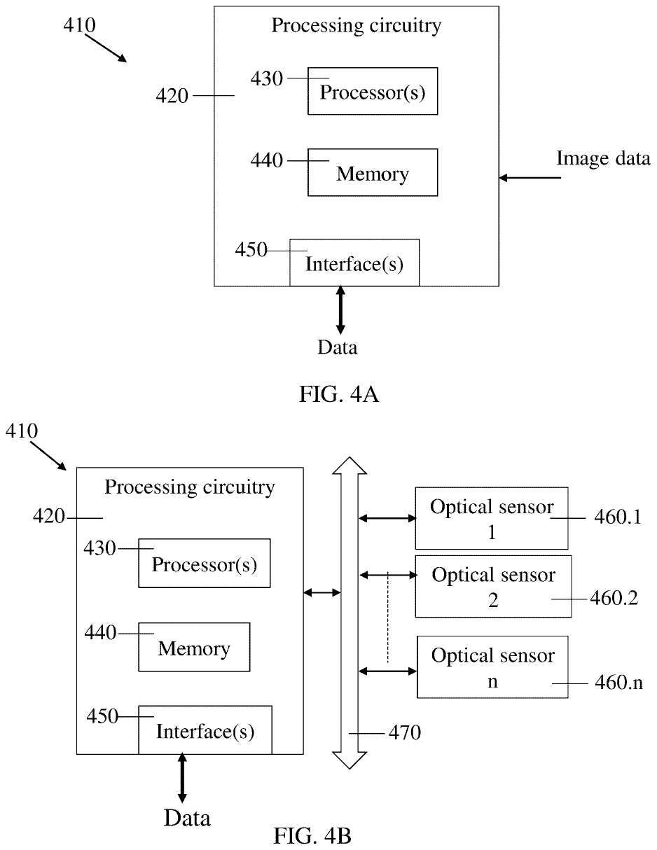

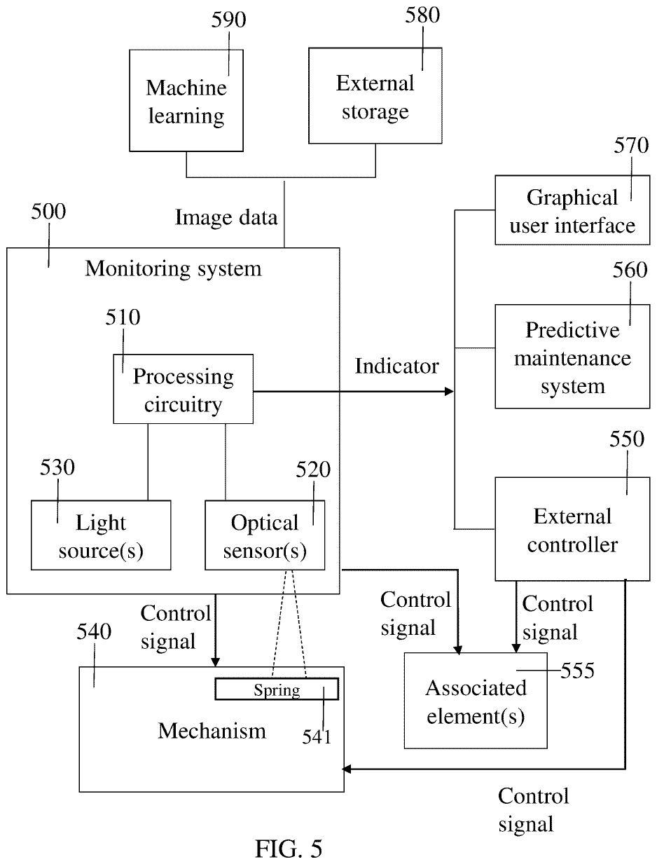

Reference is now made to FIGS. 4A-5, which are simplified block diagrams of a system for monitoring a mechanism, in accordance with respective embodiments of the invention.

In accordance with the embodiments of FIG. 4A, monitoring system 410 for monitoring a mechanism includes processing circuitry 420. Processing circuitry 420 includes one or more processors 430, and optionally additional electronic circuitry. Processor(s) 430 process the image(s) data and perform the analyses described herein. Processor(s) 430 may also perform other tasks, such as storing image data to memory 440, providing a graphical user interface (GUI) 450 to a user, processing inputs from the GUI and/or other input/output means and exporting data to an external system (e.g. a controller of the monitored system, a remote computing platform and/or a predictive health maintenance system).

FIG. 4B shows a similar system which further includes one or more optical sensors 460.1-460.n, which provide the spring image data, which is used to monitor the mechanism. Optionally, optical sensors 460.1-460.n provide the image data to processing circuitry 420 over databus 470. The skilled person will be aware of other channels which may be used to provide the image data to processing circuitry 420.

Processor(s) 430 may include one or more of a Central Processing Unit (CPU), a Graphic Processing Unit (GPU), a Tensor Processing Unit (TPU), a microprocessor, an electronic circuit, an Integrated Circuit (IC) or the like.

Optionally, the processing circuitry is in communication with the optical sensor(s) by wireless communication (e.g., Bluetooth, cellular network, satellite network, local area network, etc.) and/or wired communication (e.g., telephone networks, cable television or internet access, and fiber-optic communication, etc.).

In some embodiments, processing circuitry 420 is located at a single location as shown for clarity in FIGS. 4A-4B. In alternate embodiments, the processing circuitry is distributed in multiple locations.

Optionally, at least one optical sensor includes processing circuitry which performs at least some of the processing described herein.

Optionally, some or all of the processing circuitry is located remotely, for example in the controller of the monitored mechanism.

Optionally monitoring system 410 further includes memory 440 for internal storage of data for use by monitoring system 410. Memory 440 may be a hard disk drive, a Flash disk, a Random Access Memory (RAM), a memory chip, or the like.

The stored data may include but is not limited to:
a) Image data;
b) Data associated with the image(s). Examples of associated data may include but are not limited: to the time of image capture, environmental conditions at time of image capture, operational parameters of the machine/device/system in which the mechanism is operating and other parameters;
c) Program instructions for execution by processor(s) 430;
d) Algorithms and rules for monitoring a mechanism;
e) Failure modes of mechanisms; and
f) A model of the mechanism, optionally developed by machine learning from a training set of images of the spring or similar spring(s). For example, the model may input images of sections of the spring and output the health of the mechanism, the health of an element utilizing the mechanism, a failure alert, maintenance instructions, etc., as described in more detail below.

In some embodiments, data produced by monitoring system 410 is exported to one or more external platforms, stored on cloud storage, or the like.

Optionally, processing circuitry 420 further includes one or more interface(s) 450 for inputting and/or outputting data. For example, the interface may serve to input image(s) and/or communicate with other components in a machine and/or to communicate with external machines or systems and/or to provide a user interface.

In one example, indicators and information about the mechanism, associated elements and so forth are provided via interface(s) 450 to a HUMS, CBM or similar system.

According to some embodiments, optical sensors 460.1-460.n may include a camera. According to some embodiments, optical sensors 460.1-460.n may include an electro-optical sensor. According to some embodiments, optical sensors 460.1-460.n may include any one or more of a charge-coupled device (CCD), a light-emitting diode (LED) and a complementary metal-oxide-semiconductor (CMOS) sensor (or an active-pixel sensor), a photodetector (e.g. IR sensor, visible light sensor, UV sensor), distance measurement sensor such as a Lidar sensor, or any combination thereof. According to some embodiments, optical sensors 460.1-460.n may include any one or more of a point sensor, a distributed sensor, an extrinsic sensor, an intrinsic sensor, a through beam sensor, a diffuse reflective sensor, a retro-reflective sensor, or any combination thereof.

Optionally, processing circuitry 410 controls the operation of one or more of the optical sensor(s). Aspects of optical sensor operation which may be controlled include but are not limited to:
1) Time of image capture;
2) Exposure time;
3) Field of view;
4) Turning the optical sensor on and off (for example, turning of the optical sensor when the mechanism is not operational).

Optionally, processing circuitry 420 controls one or more light sources, where each light source illuminates at least a portion of the spring. Optionally, each light source is focused on a specific portion of the spring or reference point, which may enable reducing the required intensity of the light.

As used herein, according to some embodiments of the invention, the term “reference point” means an element on a component which may be detected by image processing and having a known location and/or orientation on the component.

A reference point may be a naturally occurring marking on the component (e.g. an irregularity that occurred during manufacturing or use) or may be deliberately added to the component.

According to some embodiments, the term “reference point” is not limiting to a specific size or shape of the reference point. For example, a reference point may be a circle, a line, an arrow, a rectangle or any other shape. It is noted that the reference point may indicate a direction in addition to its location (e.g. an arrow).

Alternately or additionally, the light source(s) are controlled by a user.

Optionally, the wavelength of the light source may be controlled by processing circuitry 420 and/or a user.

Optionally, the light sources may be configured to illuminate the mechanism and/or sections thereof.

By controlling the light sources, processing circuitry 420 and/or the user may improve the image characteristics to ease image processing and analysis. For example, a light source may be adjusted to increase contrast between the mechanism and its surroundings. Alternately or additionally, a light source may be adjusted to ease detecting faults and/or surface defects and/or structural defects by increasing shadows that highlight such areas.

According to some embodiments, the light source(s) include one or more of: a light bulb, a light-emitting diode (LED), a laser, an electroluminescent wire, and light transmitted via a fiber optic wire or cable (e.g. from an LED coupled to the fiber optic cable). Other types of light sources may also be suitable.

Optionally, processing circuitry 420 controls one or more of:
1) The direction of illumination of the light source;
2) The duration of illumination;
3) The frequency of illumination;
4) The illumination intensity;
5) Switching the light source on or off (e.g. synchronizing the illumination with the times of image capture by the optical sensor, possibly to create a strobe light effect); and
6) Changing the wavelength of illumination.

According to some embodiments, the light source may emit visible light, infrared (IR) radiation, near IR radiation, ultraviolet (UV) radiation or light in any other spectrum or frequency range which is viewable by at least one optical sensor.

Optionally, at least one optical sensor includes filter coatings for all visible and non-visible wavelengths.

According to some embodiments, a light source is a strobe light or a light source configured to illuminate in short pulses. According to some embodiments, the light source may be configured to emit strobing light without use of a shutter (such as a global shutter, rolling shutter, shutter or any other type of shutter).

Using a strobe light may be particularly useful when it is desired to obtain a clear image of a fast motion in the mechanism, such as spring release switch. It may also be easier to identify surface defects in the spring surface (such as wear and irregularities) in a clearer image), optionally as described in U.S. Provisional Pat. Appl. No. 63/394,150, and in U.S. Provisional Pat. Appl. No. 63/521,140 and corresponding PCT application filed on same date of the present PCT application which are all incorporated by reference in their entireties into the specification.

Optionally, processing circuitry 420 selects respective optimal settings for the light source(s) based on a predefined algorithm. Optionally, the light source is controlled in accordance with the environment the system being monitored is currently operating in. For example, the light source may be turned on during nighttime operation and turned off during daylight.

Optionally, processing circuitry 420 changes the light source operation dynamically during operation. For example, by using different fibers of a fiber optic cable to emit the light at different times or by emitting light from two or more fibers at once.

Optionally, the light sources are part of monitoring system 410.

According to some embodiments, the one or more optical sensors may include one or more lenses and/or a fiber optic sensor. According to some embodiments, optical sensors 460.1-460.n may include a software correction matrix configured to generate an image from the optical sensor output signal. According to some embodiments, the one or more optical sensors may include a focus sensor configured to enable the optical sensor to adjust its focus based on changes in the obtained data. According to some embodiments, the focus sensor may be configured to enable the optical sensor to detect changes in one or more pixels of the obtained signals. Optionally, the changes in the focus may be used as further input data for processing circuitry 410.

Reference is now made to FIG. 5, which is a simplified block diagram of a system for monitoring a mechanism, according to embodiments of the invention. FIG. 5 also illustrates external components that monitoring system 500 may communicate with as described below.

Monitoring system 500 includes processing circuitry 510. Optionally, monitoring system 500 includes one or more optical sensors 520 and/or one or more light sources 530.

Optional embodiments of processing circuitry 510 include one or more optical sensor(s) 520 and/or one or more light source(s) 530.

Processing circuitry 510 inputs image data of at least one section of spring 541 (in mechanism 540) from optical sensor(s) 520. Processing circuitry 510 outputs an indicator of the health of mechanism 540 based on an analysis of the range of motion in the secondary transverse direction(s). Optional embodiments are described in more detail below.

Optical sensor(s) 520 capture image data for respective sections of spring 541.

Optionally, processing circuitry 510 inputs image data from a single optical sensor at a fixed location relative to spring 541. In alternate optional embodiments, processing circuitry 510 inputs image data from multiple optical sensors, where each of the optical sensors captures image data of a respective section of spring 541.

Optionally, optical sensor(s) 541 capture image data for multiple springs in mechanism 540, which may enable better evaluation of mechanism 540.

Optionally, processing circuitry 510 controls optical sensor(s) 520, substantially as described above.

Optionally, processing circuitry 510 controls light source(s) 530, substantially as described above.

Optionally, processing circuitry 510 determines whether mechanism 540 is or is not in operation. Further optionally, processing circuitry 510 determines whether mechanism 540 is in operation based on information obtained from one or more of: another sensor (e.g. a motion sensor), and/or a system controller and/or by analysis of the image data (e.g. a blurred image may indicate that mechanism 540 is in operation while a clear image may indicate that mechanism 540 is not in operation).

Optionally embodiment, processing circuitry 510 controls the timing of image data capture (i.e. the optical sensors). For example, images may be captured only while mechanism 540 is in operation.

Optionally, the image data is tagged with information about the operational status of mechanism 540 and/or associated elements, such as whether mechanism 540 is in operation and/or environmental conditions it is operating in. The tags may be of use during analysis of the image data and/or for machine learning purposes. Optionally, the tags are displayed to a user on GUI 570.

Optionally, monitoring system 500 includes additional elements, such as a memory and/or interfaces (described with reference to FIGS. 4A-4B) but are not shown in FIG. 5 for the purpose of clarity.

Optionally, monitoring system 500 provides the indicator to one or more external systems and/or devices which take action based on the information contained in the indicator.

Optionally, monitoring system 500 provides the indicator to external controller 550. Optionally, external controller 550 analyzes the data contained in the indicator and performs selected control actions when its analysis shows that such control actions are necessary. Alternately or additionally, monitoring system 500 selects the control actions that should be performed (or are recommended) and instructs external controller 550 to perform them.

External controller 550 may control mechanism 540 and/or associated element(s) 555, such as a machine or vehicle containing mechanism 540, elements in the vicinity of mechanism 540, elements connected to mechanism 540, and so forth. Further optionally, the control actions prevent operation of mechanism 540 when a failure is detected.

Optionally, monitoring system 500 provides the indicator to predictive maintenance system 560. Predictive maintenance system 560 analyzes the data contained in the indicator along with additional data such as previously received indicators, manufacturer specifications, operational information (e.g. the time periods mechanism 540 was in operation, detected stresses, environmental conditions, etc.). Based on this analysis, predictive maintenance system 560 provides maintenance instructions for mechanism 540 and/or associated element(s) 555.

Optionally, monitoring system 500 provides the indicator for display on graphical user interface (GUI) 570. The indicator may alert a user to detected faults, failures, trends and/or modes of failure in mechanism 540. The indicator may also alert the user that action is required to maintain proper operation of mechanism 540 and/or associated element(s) 555.

Optionally, monitoring system 500 performs control actions on the mechanism 540 and/or associated element(s) 555 directly. The appropriate control action is selected based on a further analysis of the information in the indicator. Further optionally, the control actions prevent operation of mechanism 540 when a failure is detected.

Optionally, the analysis and outputting the indicator are performed in real-time, so that control operations may be performed on mechanism 540 and/or associated elements 555 in time to prevent the development of a fault and/or occurrence of a failure (for example without stopping operation or stopping operation for a short time period relative to shutdown when a failure occurs).

Optionally, monitoring system 500 outputs image data, and optionally other data (such as analysis results, labels, etc.), to external storage 580.

Optionally, monitoring system 500 outputs image data, and optionally other data, to machine learning system 590. Machine learning system 590 may update the training set for modeling the mechanism using the new image data (and/or with analysis results, labels, etc.). The updated training set may then be used to retrain the model.

Optionally, image data is not input for periods of time that mechanism is not in operation. Alternately or additionally, image data is also input when the mechanism is idle and/or not in operation in order to form a baseline for comparison with images captured during operation.

Optionally, the analysis is performed by the processing circuitry only on image data collected during operation.

Optionally, image data is input continuously from one or more optical sensors but not all data is analyzed by the monitoring system. For example, image data collected during periods of non-operation may be discarded or may be exported by the monitoring system to external systems (e.g. to an external controller) and/or for external storage (e.g. to cloud storage).

As used herein, according to some embodiments of the invention, the term “input continuously” means that image data is input even if it may not all be needed for analysis. For example, image data may be automatically collected at regular time intervals, irregular time intervals and/or during predefined time periods.

Remote monitoring systems for dampers in buildings or bridges enable the assessment of their condition and health without the need for physical inspection. For example, after a major event such as an earthquake these systems facilitate real-time data collection and analysis, providing insights into the structural behavior and performance of buildings and bridges. By remotely monitoring their health, engineers, and authorities may make informed decisions on maintenance and necessary repairs, ensuring the safety and resilience of critical infrastructure. This data may further be used for training the system.

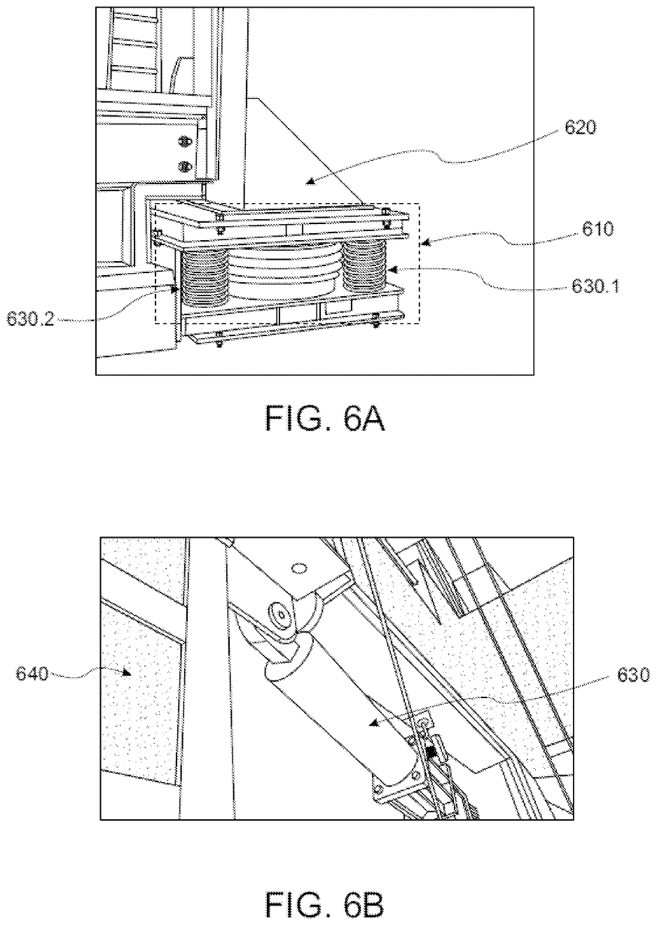

Reference is now made to FIGS. 6A-6B which are images of exemplary mechanisms which may be monitored in accordance with some embodiments of the present invention. Mechanism 610 supports machine 620, and mechanism 630 is attached to support beams 640. Both mechanisms (610 and 630) serve to dampen movements which may be caused by wind, seismic activity, oscillations from industrial processes and the like.

Mechanism 610 includes two springs 630.1-630.2, which are both visible externally. Thus the optical sensor(s) may be positioned in the vicinity of mechanism 610. The optical sensor(s) may capture image data of one or both of springs 630.1-630.2.

In mechanism 630 the spring is internal and thus the optical sensor must be placed inside the mechanism housing.

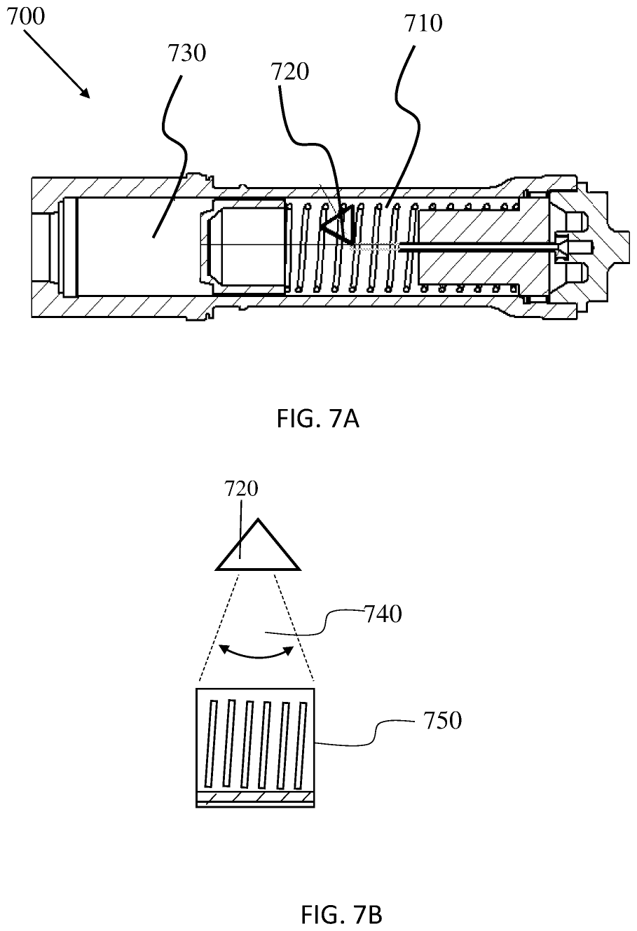

Reference is now made to FIG. 7A which is a simplified cross section of an oil reservoir damper 700 with spring 710, in accordance with exemplary embodiments of the present invention. Spring 710 and optical sensor 720, and optionally a light source (not shown), are located within the oil reservoir 730 of hydraulic damper 700. Optical sensor 720 views the spring within the oil reservoir, which would not be possible during standard maintenance examinations. This allows pinpointing of failures and defects in real-time. Additionally, unnecessary replacement of parts may be avoided.

Reference is now made to FIG. 7B, which is an enlarged view of a portion of FIG. 7A, illustrating the field of view of optical sensor 720. Optical sensor 720 is directed towards spring 710. The camera's field of view (FOV) 740 includes one or more coils of spring 710, which enables optical sensor 720 to capture an image such as image 750.

### III. Image Data Analysis

The spring image data may be analyzed to identify many factors affecting the health of the mechanism and its performance.

Optionally, the spring image data is analyzed to determine respective values of one or more parameters of the spring. The parameter values may indicate whether the spring is undergoing excessive stresses, exhibiting signs or wear, exhibiting signs of movement in directions that are not expected during proper operation of the mechanism, and other factors.

Wear may also occur when the mechanism is operating properly, and the spring parameters are within permitted norms. Optionally, determining the health of the mechanism additionally utilizes information about the time periods the mechanism was operating properly and/or time periods the stresses on the mechanism were within permitted tolerances.

Optionally, the analysis is based on multiple images of the spring.

The image data may be provided by multiple optical sensors viewing different sections of the spring and/or viewing the spring from different angles.

Alternately or additionally, the image data may be provided for multiple springs (e.g. springs 630.1 and 630.2 in FIG. 6A), possibly resulting in a more accurate evaluation of mechanism health.

Optionally, the image data includes information at multiple points in time. Further optionally, trend analysis is used to predict the future health of the mechanism. For example, the progression of a parameter value over time may be analyzed to track the development of a fault and/or to estimate a time until failure. Image data from multiple time points may also be used to analyze stresses on the mechanism over time. For example, a truck at a steady location on a bridge will result in different stresses on the bridge than multiple trucks crossing over the bridge. The different stresses may have different effects on the health of the bridge.

Optionally, the analysis is threshold-based, at least in part. One or more parameter values are compared to respective thresholds/ranges in order to determine if they conform to the desired parameter values.

Optionally, at least one spring parameter that is analyzed is a characteristic of a surface of the wire forming the spring, such as the smoothness, pattern, color and texture of the wire.

Optionally, at least one spring parameter that is analyzed is an angle or angles of the spring coils. Changes in the coil angle may indicate that the spring has moved relative to the optical sensor.

Optionally, at least one spring parameter that is analyzed is the spring pitch.

Optionally, the analysis includes comparing the shape of a wire forming the spring to a baseline shape of the wire.

Optionally, the analysis includes comparing the current length of the spring to an expected length of the spring under a known force.

Optionally, the analysis includes comparing the current length of the spring to an expected length of the spring when no force is applied to the spring.

Optionally, the analysis includes comparing the shape of the spring to a baseline shape of the spring. For example, the analysis may detect that a helical spring has become deformed when the angles between the coils are determined to be non-uniform.

Other parameters of the spring which may be used in the analysis include but are not limited to:
a. Type of spring—linear or non-linear spring, compression or extension spring, etc.;
b. Coil inner and/or outer diameter;
c. Spring stiffness;
d. Spring material;
e. Spring ends; and
f. Composition of the spring.

Optionally, the analysis includes calculating a movement of a reference point on the spring in a series of image. This analysis may show the motion of the reference point relative to the camera or other fixed location.

Optionally, the analysis includes comparing the rate of change of a distance between reference points on respective coils of the spring to an expected rate of change (i.e. the speed of compression and/or extension of the spring). Fast compression and extension may indicate that a large force was put on the mechanism, for example during an aircraft hard landing.

Optionally, the analysis includes comparing the rate of change of at least one spring parameter to an expected rate of change of that parameter.

Optionally, the analysis is further based on known physical properties of the spring, such as the size and shape of wire, the stiffness of spring, the length of spring, angles between spring portions, changes in pattern of spring, misalignment between spring portions and/or other properties.

Optionally, the analysis is further based on known operating conditions of the mechanism, such as the occurrence of seismic events, temperature conditions, periods of operation and idling, etc.

Optionally, the analysis comprises detecting events that occurred to the mechanism. For example, extremely rapid compression of the spring in an oscillation and/or vibration prevention system may indicate extreme wind conditions which require immediate examination of the mechanism or associated element (e.g. building or power cables).

Optionally, the processing circuitry calibrates the mechanism and/or associated elements in order to determine baseline parameter values for the analysis.

The results of the image analysis may be correlated with information from one or more other sensors or external sources. Non-limiting examples of other sensors include:
1) Motion sensor (e.g. accelerometer, gyroscope, magnetometer, magnetic compass, vibration or tilt sensor);
2) Temperature sensor;
3) Environmental conditions;
4) Control system information (e.g. times of operation of the mechanism, load, time since last maintenance of the mechanism, time since last replacement of the spring, etc.).

In one example, a motion sensor gives information about times that the mechanism is operation, and images from those times may be used to evaluate the health of the mechanism.

In a second example, a temperature sensor provides information about the temperature of the mechanism. The health of the mechanism may be considered to deteriorate more quickly when it is operating at a high temperature.

In a third example, the health of the mechanism may be considered to decline over time since previous maintenance.

### IV. Generating and Outputting an Indicator

An indicator is generated based on the results of the analysis of the images of the spring. The indicator may be output to external elements as described herein and/or used by the processing circuitry to control the mechanism, according to any of the embodiments described herein. The indicator may be formatted in any suitable format known in the art.

The indicator may provide many types of information relating to varied aspects of the health of the mechanism.

Optionally the indicator includes one or more of:
a) maintenance instructions;
b) a time to failure estimation;
c) a failure alert;
d) a trend towards failure; and
e) operating instructions in response to a detected failure.

Optionally, the indicators are output to a control system and/or preventive maintenance system, which decide whether further actions should be taken.

Optionally, the indicator is output to a controller which controls mechanism operation based on the indicator.

Optionally, the indicator is output to a preventive maintenance system which provides maintenance instructions based on the indicator.

Optionally, the indicator is displayed on a user interface. The indicator may alert a user to a fault or failure or may provide any other information that may be of use to the user.

The data included in the indicator may be adapted to the element to which it is being sent. For example, an indicator provided to an external controller may be a general health rating for the mechanism (e.g. on a numerical scale) and an alert when a failure is detected. In a second example, an indicator displayed to a user may include trend analysis, fault and failure alerts, and/or maintenance instructions. In another example, an indicator to a predictive maintenance system may include only parameter values, for further analysis by the predictive maintenance system.

Optionally, the indicator includes the images and/or videos of the mechanism, further optionally at slow motion in order to enable a technician to evaluate.

Optionally, the indicator includes a graph or diagram representing the function of the spring, such as strains or stresses on the spring and/or the displacement of reference points on the spring.

Optionally, the indicator includes information received from other sources, such as external sensors, information from a control system, etc.

The time(s) at which the analysis and the generation of the indicator are performed may be tailored to the needs of a particular system, machine, aircraft, etc. Examples of when the analysis and indicator output may be performed include but are not limited to:
1) Ongoing;
2) Periodically;
3) Only during operation or during specific operational task(s) (e.g. landing of an aircraft);
4) Both during operation and during idle time periods.
5) When an indication of a problem is received, for example from other sensors in the system.

Optionally the analysis is performed more frequently when certain conditions appear (e.g. high temperature).

Optionally, the analysis and indicator output are performed once a second, once every several seconds, once a minute, once an hour, once a day, once a week, once every several weeks, once a month, once every several months or any range therebetween.

### IV.1. Data Structure

Optionally, the indicator is retrieved from a data structure indexed by at least one parameter determined from the analysis of images of the spring, and optionally additional information.

Parameters and information which may be used to retrieve the indicator from the data structure include but are not limited to:
1) A spring parameter;
2) The rate of change of a spring parameter;
3) Trend(s) in a spring parameter and/or other health-related parameters of the mechanism over time. The trends may be evaluated based on any technique known in the art, for example statistical methods, machine learning algorithms or expert-defined criteria, moving averages, linear regression or pattern recognition algorithms.
4) Data obtained from other sensors (e.g. motion sensors, temperature sensors, optical sensors imaging other elements, etc.).
5) Data provided by element(s) associated with mechanism (e.g. an external system controller).
6) Information about other components of the mechanism.
7) Information about the vicinity of the mechanism (e.g. puddling of liquid near the mechanism).

Optionally, spring parameters include but are not limited to:
a) A characteristic of a surface of a wire forming the spring;
b) An angle of coils of the spring;
c) The pitch of the coils of the spring;
d) A shape of a wire forming the spring;
e) The length of the spring under a known force;
f) The length of the spring in an absence of force; and
g) Information about the shape of the spring.

In a simplified example, the health analysis is based on parameter the value and rate of change of a spring's pitch parameters. In this example, a fast rate of change is 1 mm/millisecond and a slow rate of change is less than 1 mm/millisecond.

If the spring's pitch value is below 10 mm and the rate of change is slow, the health indicator suggests that the damper is operating within the desired range and indicates good health. No immediate action is required.

If the spring's pitch value is below 10 mm and the rate of change is fast, it indicates a sudden impact on the mechanism. Although it is still within the desired range, the fast rate of change raises concern, and further investigation may be required.

If the spring's pitch value falls within the range 10 mm to 15 mm (inclusive) and the rate of change is slow, the health indicator signals that the damper's operation is non-optimal but still within an accepted tolerance. No immediate action is needed, but a predictive maintenance system may update the maintenance schedule to address potential faults proactively.

If the spring's pitch value falls within the range 10 mm to 15 mm (inclusive), and the rate of change is fast, it suggests that a fault has been detected. Immediate action may be required to investigate and address the sudden impact or anomaly.

If the spring's pitch value is above 15 mm and the rate of change is slow, the health indicator indicates a mechanism failure and immediate action is needed to address the issue.

If the spring's pitch value is above 15 mm and the rate of change is fast, it suggests that an impact has been detected, possibly due to a sudden failure or severe damage. Immediate action is required to investigate and rectify the situation.

Reference is now made to Table 1, which is a simplified example of a data structure that may be used to select an indicator for output.

TABLE 1

| Spring's Pitch | Rate of | Health | |
|---|---|---|---|
| Parameter Range | Change | Indicator | System Action |
| Pitch < 10 mm | Slow ≤ | Good Health | No action needed |
| | 1 mm/ms | | |
| | Fast > | Good Health | No action needed |
| | 1 mm/ms | | |
| Amm ≤ Pitch ≤ | Slow ≤ | Non-optimal | Shorter |
| 15 mm | 1 mm/ms | | maintenance |
| | | | interval |
| | Fast > | Fault Detected | Immediate action |
| | 1 mm/ms | | needed |
| Pitch > 15 mm | Slow ≤ | Mechanism | Immediate action |
| | 1 mm/ms | Failure | needed |
| | Fast > | Impact Detected | Immediate action |
| | 1 mm/ms | | needed |

### IV.2. Model-Based Evaluation

Alternately or additionally, evaluation of the health of the mechanism and/or selecting the indicator to be output is based on a model. The model may be developed by any means known in the art.

In some embodiments, the model used for evaluation the health of the mechanism and/or selecting the indicator to be output is a machine learning model trained with a training set by supervised learning algorithm or by a non-supervised learning algorithm. Optionally, the model is a neural network.

Optionally, the training set includes one or more of:
1) Images collected of the mechanism and/or associated elements or a similar mechanism and/or associated elements during periods of operation or during specific operational task(s);
2) Images collected of the mechanism and/or associated elements or a similar mechanism and/or associated elements during periods of non-usage;
3) Images collected of the mechanism and/or associated elements, or a similar mechanism and/or associated elements during similar stresses;
4) Image(s) of an associated element;
5) Image(s) of a peripheral components connected to the mechanism, possibly provided by other optical sensors; and
6) Image(s) of the vicinity of the mechanism, possibly provided by other optical sensors.
7) Non-image data associated with some or all of the images in the training set. For example the non-image data may include environmental and operational conditions when the image was captured.

Optionally, some or all of the images are tagged with associated information, such as the length or other proportion of the spring when the image data was captured, a known force applied to the spring when the image data was captured, whether a fault or failure had been detected when the image data was captured, a motion of a mechanism component, etc.

Optionally, the model is trained prior to actual use of the mechanism and/or associated elements (e.g. during a preliminary training period).

Optionally, the model is trained during a preliminary training period on image data of similar mechanism and/or associated elements and/or on mechanism and/or associated elements in similar systems.

Optionally, the model is periodically retrained based on image(s) and or other data collected over time.

In an exemplary embodiment, a torsion spring in an aircraft landing gear system is monitored. The torsion spring is responsible for absorbing and storing energy during takeoff and landing. When the landing gear is deployed or retracted, the torsion spring experiences twisting deformation to provide the necessary force to support the aircraft's weight and absorb impact during touchdown.

Optical sensors capture image data of the torsion spring. The image data is input into a model which compares the real-time image data with the baseline images to detect any deviations in the torsion spring's twisting behavior (such as spring twist angle and overall deformation pattern). The model outputs an indicator of the health of the landing gear based on the deviations found (or not found) in the torsion spring behavior.

### V. Monitoring Other Components

Optionally, the monitoring system also inputs images of other components in the associated elements (e.g. machine/vehicle/aircraft/etc.) and performs additional evaluation, optionally as described in PCT Publ. WO2022162663, US Provisional Pat. Appl. No. 63/394,150, U.S. Provisional Pat. Appl. No. 63/521,140 and corresponding PCT application filed on same date of the present PCT application, and US Provisional Pat. Appl. No. 63/364,161 and corresponding PCT application filed on same date of the present PCT application, which are incorporated by reference in their entireties into the specification. The images may be provided by the optical sensors imaging the spring and/or by other optical sensors. The additional analysis may identify defects, faults or failures not necessarily related directly to the spring, such as corrosion, cracks, structural damage, etc. The additional analysis may be combined with the analysis described herein to provide a more complete analysis of the mechanism and components thereof.

### VI. Method of Monitoring a Mechanism

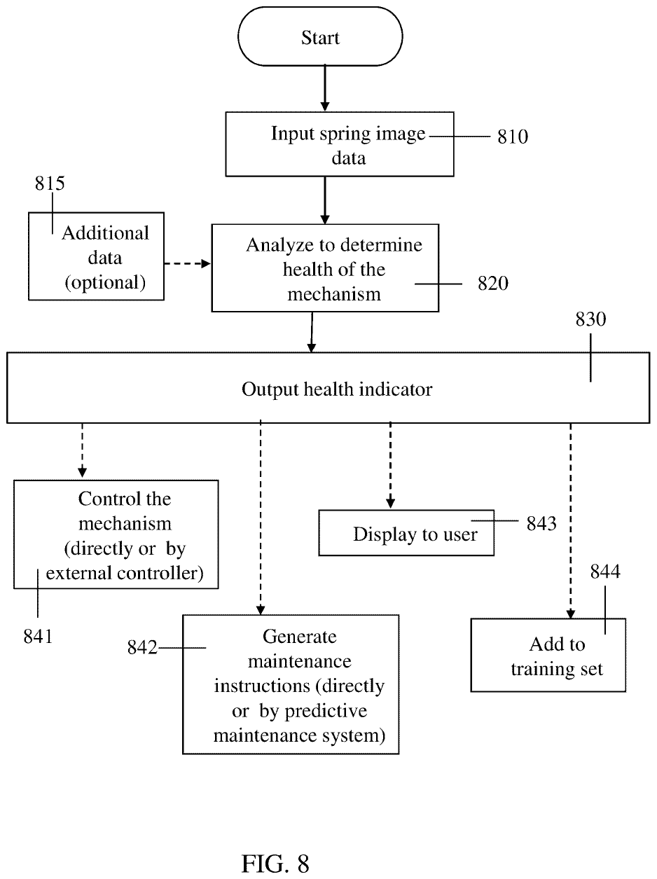

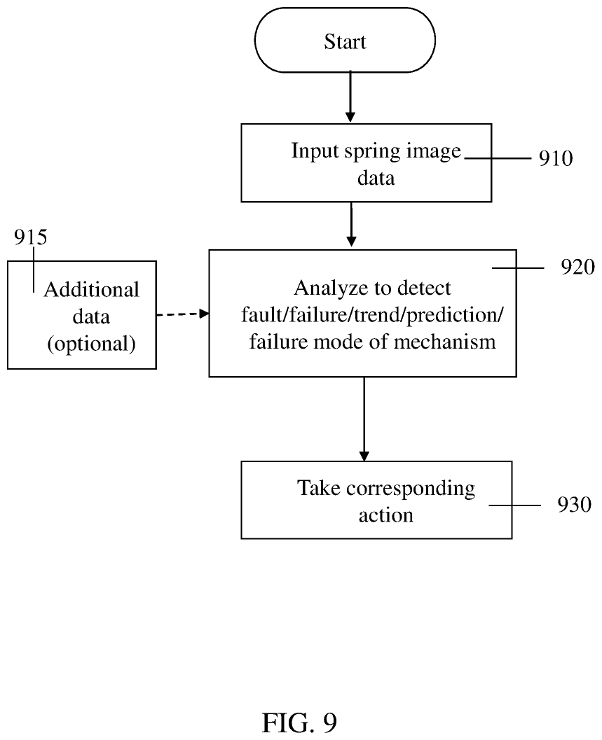

Reference is now made to FIGS. 8-9 which are simplified flowcharts of methods for monitoring a mechanism, according to respective embodiments of the invention. Optional embodiments of inputting image data, analysis of the image data and generating and outputting the indicator are described above.

Optionally, the mechanism is a damper configured to dampen oscillations of the spring.

Referring to FIG. 8, in 810 image data of at least one section of at least one spring is input from at least one optical sensor.

Optionally, in 815 additional data is input from at least one external optical sensor and/or non-optical sensor. Examples of additional data include images from optical sensors that are not imaging the spring(s), data from seismic sensors, motion sensors, temperature sensors, vibration sensors, sound sensors, etc. Optionally, control data from the mechanism controller is also provided.

In 820, the image data (and optionally additional data) is analyzed to determine the health of the mechanism. Optionally, the analysis is based on multiple images. The multiple images may be captured by the same optical sensor at different times and/or be captured by multiple optical sensors viewing different sections of the spring or viewing additional springs in the same mechanism. Optionally, the multiple images include a video sequence.

Optionally, the analysis comprises detecting events that occurred to the mechanism.

Optionally, the analysis includes predicting the future health of said mechanism by performing trend analysis.

Optionally, the analysis includes predicting a future health of the mechanism by performing trend analysis on changes in the image data over time.

Optionally, the analysis includes determining, from the image data, whether at least one parameter value of the spring is within a respective specified range, and/or above or below specified threshold(s).

Optionally, the analysis includes calculating the movement of a reference point on the spring over time by analyzing a sequence of images.

Optionally, the analysis includes calculating the rate of change of the distance between reference points on respective coils of the spring.

Optionally, the analysis includes calculating the rate of change of at least one parameter of the spring.

Optionally, parameters of the spring include but are not limited to:
a) a characteristic of a surface of a wire forming the spring;
b) an angle of coils of the spring;
c) a pitch of coils of the spring;
d) a shape of a wire forming the spring;
e) a length of the spring under a known force;
f) a length of the spring in an absence of force; and
g) information about the shape of the spring.

In 830 an indicator of the health of the mechanism is output.

Optionally, the indicator is output to a controller that controls mechanism operation based on the indicator and/or to a preventive maintenance method that provides maintenance instructions based on the indicator.

Optionally, the indicator is indicative of the health of components other than the spring.

Optionally, the indicator is output to a controller which controls operations of the mechanism based on the health of the mechanism, in order to prevent operation of the mechanism during failure.

Optionally, the indicator is output to a preventive maintenance system which provides maintenance instructions based on the indicator. Following the maintenance instructions may prevent a fault from developing into a failure.

Optionally, the method further includes displaying the indicator on a user interface in order to alert a user of the health of the mechanism.

Optionally, the indicator includes one or more of:
maintenance instructions;
a time to failure estimation;
a failure alert; and
operating instructions in response to a detected failure.

Optionally, the indicator is retrieved from a data structure indexed, at least in part, by at least one spring parameter value.

Optionally, the analysis is based on a machine learning model trained using a training set of images collected during operation of at least one of the mechanism and a similar mechanism. Optionally, the machine learning model is a neural network.

Optionally, the machine learning model is trained using a supervised learning algorithm or an unsupervised learning algorithm.

Optionally, the method further includes controlling the mechanism directly and/or by an external controller based on the indicator 841.

Optionally, the method further includes generating maintenance instructions directly and/or by a predictive maintenance system 842.

Optionally, the method further includes displaying information to the user on a user interface 843. The displayed information includes some or all of the results of the analysis of the image data of the mechanism. Further optionally, the displayed information includes an alert that the mechanism and/or associated element require attention (e.g. shutoff).

Optionally, the method further includes outputting the indicator and/or image data to a machine learning system 844. The machine learning system may use the information provided to train and/or retrain a model of the mechanism.

According to some embodiments, at least some of the mechanism is covered or enclosed by a housing and an optical sensor viewing the spring is mounted within the housing.

Optionally, the method further includes controlling at least one light element.

The light element is mounted within said housing and is positioned to provide illumination during image data capture by the optical sensor.

Referring now to FIG. 9, in 910 image data of at least one section of a spring is input from at least one optical sensor.

Optionally, in 915 additional data is input from at least one optical sensor and/or non-optical sensor. Examples of additional data include images from optical sensors that are not imaging other spring, data from seismic sensors, motion sensors, temperature sensors, etc.

In 920, the image data (and optionally additional data) is analyzed to detect one or more aspects relating to the health of the mechanism.

Optionally, one aspect that may be detected is a fault detected in the mechanism.

Optionally, one aspect that may be detected is a failure detected in the mechanism.

Optionally, one aspect that may be detected is a trend in the progression of a fault detected in the mechanism.

Optionally, one aspect that may be detected is a prediction of a time to failure of the mechanism and/or an associated element.

Optionally, one aspect that may be detected is an identified failure mode.

Examples of failure modes include but are not limited to:
1) Spring Fatigue: Repeated stress cycles over time may lead to material fatigue, causing the spring to lose its elasticity and ultimately fail.
2) Spring Settling: Prolonged compression or loading may cause the spring to settle or take a permanent set, leading to reduced performance.
3) Spring Buckling: Excessive axial compression or bending forces may cause the spring to buckle, leading to deformation and failure.
4) Spring Creep: Long-term exposure to sustained loads may cause the spring to deform or creep over time.
5) Spring Corrosion: Exposure to corrosive environments or substances may lead to the degradation of the spring material, reducing its strength and causing failure.
6) Spring Overloading: Applying forces beyond the spring's rated capacity may cause it to exceed its elastic limits and fail.
7) Spring Fracture: High impact or shock loading may lead to spring fracture or breaking.
8) Spring Misalignment: Misalignment or uneven loading may cause stress concentrations, leading to premature failure.
9) Spring Wear: Friction and wear between coils or with other components may lead to loss of material and eventual failure.
10) Spring Fatigue Cracking: Cyclic loading may create small cracks in the spring, which may propagate and result in failure over time.
11) Spring Relaxation: Over time, a spring may lose some of its tension or force, reducing its effectiveness.
12) Spring Dislocation: Improper assembly or installation may cause the spring to dislocate or become unseated, affecting its performance.

Optionally, one aspect that may be detected is a trend of a failure mode.

Optionally, one aspect that may be detected is whether a specified failure mode is present in the mechanism.

In 930 at least one action is taken based on the analysis of the health of the mechanism.

Optionally, the at least one action is controlling the mechanism and/or associated elements.

Optionally, the at least one action is outputting an indicator of the health of the mechanism and/or associated elements.

Optionally, the at least one action is outputting an alert of a failure in the mechanism and/or associated elements.

Optionally, the at least one action is outputting an alert of an expected failure in the mechanism and/or associated elements.

Optionally, the at least one action is obtaining operating and/or maintenance instructions appropriate for a mechanism with the health aspects determined in 920. Further optionally, the operating and/or maintenance instructions are provided to a user.

### VII. Monitoring a Damper

A system and method for monitoring a damper associated with a spring are now presented. The system and method may include any of the above described embodiments which are suitable for the given arrangement of the damper and spring within the mechanism (including but not limited to the embodiments illustrated in FIGS. 4A-5, 8 and 9).

There are many possible ways to form a mechanism having an associated damper and spring(s). In some embodiments the damper and spring are connected in parallel. In alternate embodiments the damper and spring are connected in series. An exemplary mechanism with damper and spring in series is shown in FIGS. 7A-7B.

According to some embodiments of the invention, a system for monitoring a damper includes processing circuitry. The processing circuitry inputs image data of at least one section of a spring associated with the damper from at least one optical sensor. The image data is analyzed and an indicator of the health of the damper is provided based on the analysis.

Optionally, the damper and spring are arranged to work together to control the motion of a system. The spring provides a restoring force that returns the system back to its original position while the damper controls the rate of return, preventing the system from oscillating.

Spring/damper combinations are used in many applications, including but not limited to:
a. Vehicle suspension systems;
b. Vibration isolation systems;
c. Shock absorbers; and
d. Seismic dampers.

Optionally, the optical sensor is mounted within the body of the damper.

Optionally, the optical sensor is mounted within the fluid of a viscous damper.

Optionally, the damper monitoring system further includes at least one light element positioned to illuminate at least a portion of the spring during image data capture by the optical sensor.

Optionally, the analysis includes determining, from the image data, a respective conformance of at least one parameter value of the spring to a specified range of the parameter. Conformance may be determined, for example, by comparing the parameter value to a specified threshold or range.

Optionally, the analysis includes determining events that occurred to the damper.

Optionally, the indicator is indicative of the health of damper components that are not the spring.

According to some embodiments of the invention, a method for monitoring a damper includes inputting image data of at least one section of a spring associated with the damper from at least one optical sensor and providing an indicator of a health of the damper based on an analysis of the image data.

Optionally, the optical sensor is mounted within a body of the damper.

Optionally, the optical sensor is mounted within fluid of a viscous damper.

Optionally, the method further includes controlling comprising at least one light element positioned to illuminate the at least one section of the spring during image data capture by the optical sensor.

Optionally, the analysis includes determining, from the image data, the conformance of at least one parameter value of the spring to a specified range of the parameter.

Optionally, the analysis includes determining events that occurred to the damper.

Optionally, the indicator is indicative of a health of components of the damper other than the spring.

### VIII. Exemplary Embodiments

According to some embodiments, there is provided an exemplary system for monitoring potential failure in a mechanism comprising a spring and/or elements associated with the mechanism. According to some embodiments, the system may be configured to receive signals from the at least one optical sensor positioned on or in vicinity of the spring and/or an object attached thereto and/or the mechanism and/or associated element, and to receive signals therefrom.

According to some embodiments, the system may be configured to identify at least one change in the received signals. According to some embodiments, for an identified change in the received signals, the system may be configured to apply the at least one identified change to an algorithm configured to analyze the identified change in the received signals and to classify whether the identified change in the received signals may be associated with a mode of failure of the mechanism, and optionally an associated element, thereby labeling the identified change as a fault, based, at least in part, on obtained data associated with a failure mode of the mechanism, and optionally an associated element. According to some embodiments, for an identified change that may be classified as being associated with a mode of failure, the system may output a signal indicative of the identified change associated with the mode of failure.

According to some embodiments, the system may be configured to generate at least one model of a trend in the identified fault, wherein the trend may include a rate of change in the fault.

Optionally, the system for monitoring potential failure in a mechanism, and optionally an associated element, may be used to monitor vehicles such as cars, trucks, motorcycles, bicycles, scooters, trains, etc., aviation vehicles such as drones, helicopters and airplanes, etc., mechanical elements such as actuators, dampers, wind turbines, etc., structural elements such as high tension cables, bridges, buildings, stadiums, etc.

According to some embodiments, the system may be configured to prevent failure of the mechanism, and optionally an associated element, by identified a fault in real time and monitoring the changes of the fault in real time.

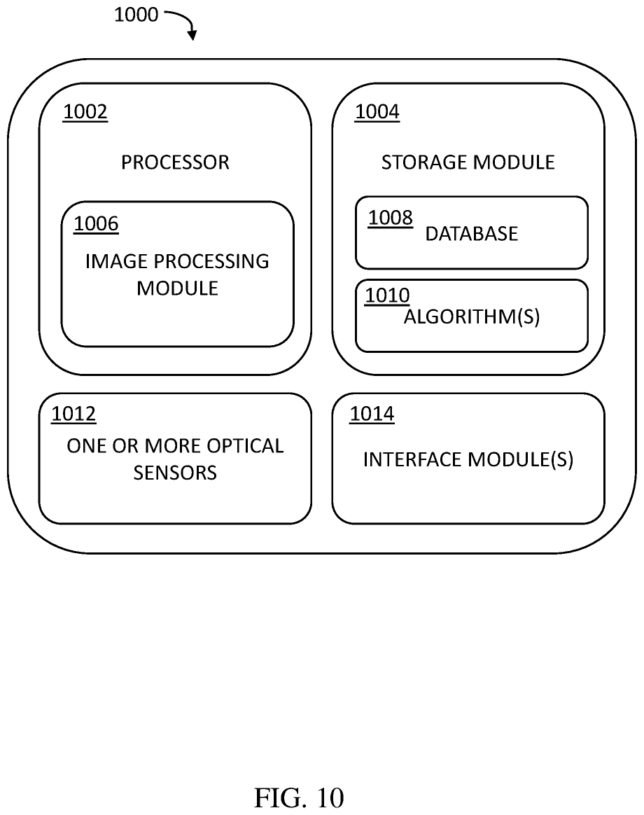

Reference is made to FIG. 10, which shows a simplified schematic illustration of a system for monitoring potential failure in a mechanism, and optionally in an associated element, in accordance with some embodiments of the present invention.

According to some embodiments, the system 1000 for monitoring potential failure in a mechanism which includes a spring may be configured to monitor the mechanism, and optionally an associated element, the spring and/or object attached thereto, a component of the mechanism, two or more components of the mechanism, component(s) of the associated element, or any combination thereof.

According to some embodiments, the system 1000 may include one or more optical sensors 1012 configured to be fixed on or within or in the vicinity of the spring and/or an object attached thereto. Optical sensor(s) 1012 are fixed such that their respective fields of view encompass all or a portion of the spring. According to some embodiments, the system 1000 may be configured to monitor the mechanism, and optionally an associated element, in real time. According to some embodiments, the system 1000 may include at least one processor 1002 in communication with the one or more optical sensors 1012. According to some embodiments, the processor 1002 may be configured to receive signals (or data) from the one or more optical sensors 1012. According to some embodiments, the processor 1002 may include an embedded processor, a cloud computing system, or any combination thereof. According to some embodiments, the processor 1002 may be configured to process the signals (or data) received from the one or more optical sensors 1012 (also referred to herein as the received signals or the received data). According to some embodiments, the processor 1002 may include an image processing module 1006 configured to process the signals received from the one or more optical sensors 1012.

According to some embodiments, the one or more optical sensors 1012 may be configured to detect light reflected from the surface of the spring. This may be advantageous since surfaces with different textures reflect light differently. For example, a matt surface may be less reflective and may scatter (diffuse) light equally in all directions, in comparison with a polished surface, which would reflect more light than an unpolished one, because it has an even surface and reflects most of the light rays parallel to each other. A polished surface, being smooth and lustrous, may absorb a very little amount of light and may reflect more light, thereby the image detected from light that reflects from a polished surface may be clearer than an image detected from light reflected off an unpolished surface. Thus, the surface texture of a fracture, crack or any other surface defect may be different from the un-damaged surface surrounding it (or in other words, the original base-line surface), therefore the different light reflections from the surfaces allow the detection of small defects. Moreover, by changing the wavelengths, intensity, and/or directions of the light, this phenomenon can be intensified. According to some embodiments, and as described in greater detail elsewhere herein, the system may include one or more light sources configured to illuminate the spring.

According to some embodiments, changing the direction of the light may include moving the light sources. According to some embodiments, changing the direction of the light may include maintaining the position of two or more light sources fixed, while powering (or operating) the light sources at different times, thereby changing the direction of the light that illuminates the spring. According to some embodiments, and as described in greater detail elsewhere herein, the system may include one or more light sources positioned such that operation thereof illuminates the spring. According to some embodiments, the system may include a plurality of light sources, wherein each light source may be positioned at a different location in relation to the spring.

According to some embodiments, the wavelengths, intensity and/or directions of the one or more light sources may be controlled by the processor. According to some embodiments, changing the wavelengths, intensity and/or directions of the one or more light sources thereby enables the detection of surface defects on the surface of the spring. According to some embodiments, the one or more optical sensors 1012 may enable the detection, by analyzing the reflected light, of microscopic dents and/or defects, such as, for example, 2-3 tenths of a millimeter, which may be invisible to the naked eye. According to some embodiments, wavelengths in the visible spectrum may be used. According to some embodiments, wavelengths above and/or below the visible spectrum may be used.

According to some embodiments, the one or more optical sensors 1012 may include a camera. According to some embodiments, the one or more optical sensors 1012 may include an electro-optical sensor. According to some embodiments, the one or more optical sensors 1012 may include any one or more of a charge-coupled device (CCD) and a complementary metal-oxide-semiconductor (CMOS) sensor (or an active-pixel sensor), or any combination thereof. According to some embodiments, the one or more optical sensors 1012 may include any one or more of a point sensor, a distributed sensor, an extrinsic sensor, an intrinsic sensor, a through beam sensor, a diffuse reflective sensor, a retro-reflective sensor, or any combination thereof.

According to some embodiments, the one or more optical sensors may include one or more lenses and/or a fiber optic sensor. According to some embodiments, the one or more optical sensor may include a software correction matrix configured to generate an image from the obtained data. According to some embodiments, the one or more optical sensors may include a focus sensor configured to enable the optical sensor to detect changes in the obtained data. According to some embodiments, the focus sensor may be configured to enable the optical sensor to detect changes in one or more pixels of the obtained signals.

According to some embodiments, the system 1000 may include one or more interface modules 1014 in communication with the processor 102. According to some embodiments, the interface module 1014 may include a user interface module that is configured for receiving data from a user, wherein the data may be associated with any one or more of the spring and/or object attached thereto and/or mechanism and/or associated element, the type of spring and/or mechanism and/or associated element, the type of system in which the spring and/or mechanism and/or associated element operates, the mode(s) of operation of a spring and/or mechanism and/or associated element, the user(s) of the spring and/mechanism and/or associated element, one or more environmental parameters, one or more modes of failure of the spring and/or mechanism and/or associated element, or any combination thereof.

According to some embodiments, the user interface module may include any one or more of a keyboard, a display, a touchscreen, a mouse, one or more buttons, or any combination thereof. According to some embodiments, the user interface module may include a configuration file which may be generated automatically and/or manually by a user. According to some embodiments, the configuration file may be configured to identify the at least one segment. According to some embodiments, the configuration file may be configured to enable a user to mark and/or select the at least one segment.

According to some embodiments, the system 1000 may include a storage module 1004 configured to store data and/or instructions (or code) for the processor 1002 to execute. According to some embodiments, the storage module 1004 may be in communication (or operable communication) with the processor 1002. According to some embodiments, the storage module 1004 may include a database 1008 configured to store data associated with any one or more of the system 1000, the spring and/or mechanism and/or associated element, user inputted data, one or more training sets (or data sets used for training one or more of the algorithms), or any combination thereof. According to some embodiments, the storage module 1004 may include one or more algorithms 1010 (or at least one computer code) stored thereon and configured to be executed by the processor 1002. According to some embodiments, the one or more algorithms 1010 may be configured to analyze and/or classify the received signals, as described in greater detail elsewhere herein. According to some embodiments, and as described in greater detail elsewhere herein, the one or more algorithms 1010 may include one or more preprocessing techniques for preprocessing the received signals. According to some embodiments, the one or more algorithms 1010 may include one or more machine learning models.

According to some embodiments, the one or more algorithms 1010 may include a change detection algorithm configured to identify a change in the received signals. According to some embodiments, the one or more algorithms 1010 and/or the change detection algorithm may be configured to receive signals from the one or more optical sensors 1012, obtain data associated with characteristics of at least one mode of failure of the spring and/or mechanism and/or associated element, and/or identify at least one change in the received signals.

According to some embodiments, the one or more algorithms 1010 may include a classification algorithm configured to classify the identified change. According to some embodiments, the classification algorithm may be configured to classify the identified change as a fault. According to some embodiments, the classification algorithm may be configured to classify the identified change as a normal performance (or motion) of the spring and/or mechanism and/or associated element.

According to some embodiments, the one or more algorithms 1010 may be configured to analyze the fault (or the identified change classified as a fault). According to some embodiments, the one or more algorithms 1010 may be configured to output a signal (or alarm) indicative of the identified change being associated with the mode of failure.

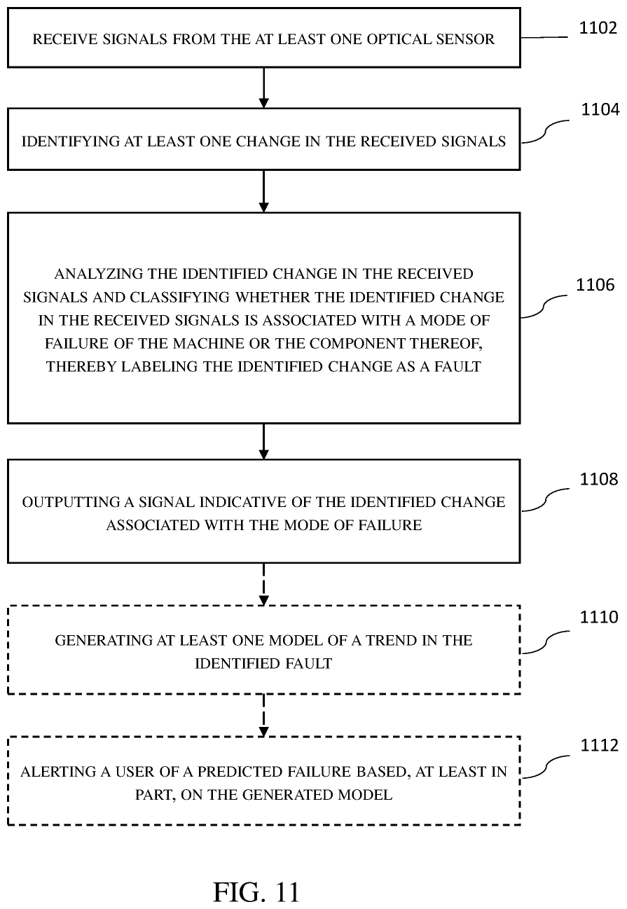

According to some embodiments, the one or more algorithms 1010 may be configured to execute, via the processor 1002, the method for monitoring potential failure in a mechanism and/or associated element, such as the method depicted in FIG. 11.

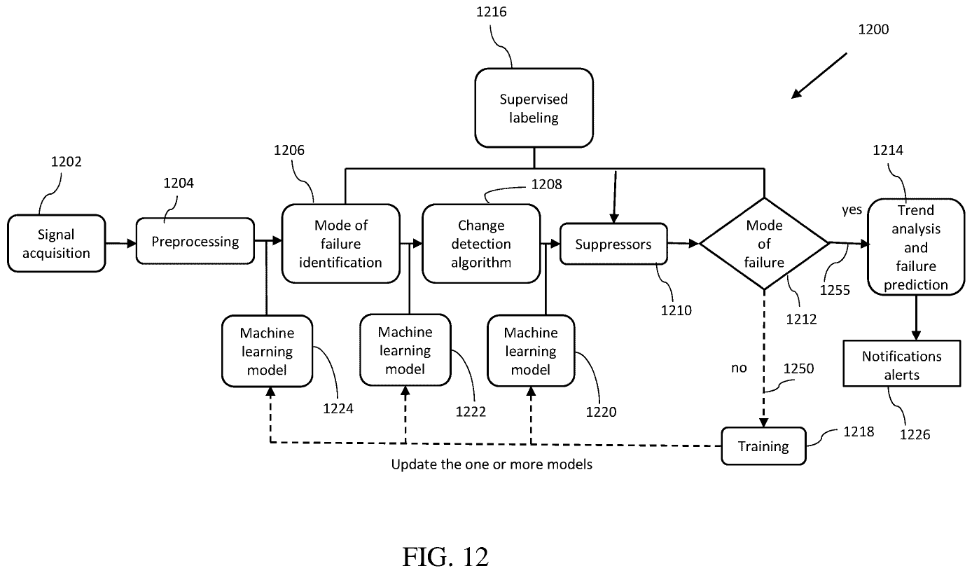

Reference is made to FIG. 11, which shows a simplified flowchart of functional steps in a computer implemented method for monitoring potential failure in a mechanism, and optionally in an associated element, in accordance with some embodiments of the present invention, and to FIG. 12, which shows a simplified schematic block diagram of a method for monitoring potential failure in a mechanism, and optionally in an associated element, in accordance with some embodiments of the present invention. According to some embodiments, the method of FIG. 11 may include one or more steps of the block 1200 of FIG. 12.

According to some embodiments, at step 1102, the method may include identifying at least one change in the received signals. According to some embodiments, at step 1104, the method may include identifying at least one change in the received signals. According to some embodiments, at step 1106, the method may include analyzing the identified change in the received signals and classifying whether the identified change in the received signals may be associated with a mode of failure of the mechanism and/or associated element, thereby labeling the identified change as a fault. According to some embodiments, at step 1108, the method may include outputting a signal indicative of the identified change associated with the mode of failure. According to some embodiments, at step 1110, the method may include generating at least one model of a trend in the identified fault. According to some embodiments, at step 1112, the method may include alerting a user of a predicted failure based, at least in part, on the generated model.

According to some embodiments, such as depicted in FIG. 12, the method may include signal acquisition 1202, or in other words, receiving one or more signals. According to some embodiments, the method may include receiving one or more signals from at least one optical sensor fixed on or within or in vicinity of the spring and/or mechanism and/or associated element, such as, for example, one or more sensors 1012 of system 1000. According to some embodiments, the one or more signals may include one or more images. According to some embodiments, the one or more signals may include one or more portions of an image. According to some embodiments, the one or more signals may include a set of images, such as a packet of images. According to some embodiments, the one or more signals may include one or more videos.

According to some embodiments, the method may include preprocessing (1204) the one or more signals. According to some embodiments, the preprocessing may include converting the one or more signals into electronic signals (e.g., from optical signals to electrical signals). According to some embodiments, the preprocessing may include generating one or more images, the one or more sets of images, and/or one or more videos, from the one or more signals. According to some embodiments, the preprocessing may include dividing the one or more images, one or more portions of the one or more images, one or more sets of images, and/or one or more videos, into a plurality of tiles. According to some embodiments, the preprocessing may include applying one or more filters to the one or more images, one or more portions of the one or more images, one or more sets of images, one or more videos, and/or a plurality of tiles. According to some embodiments, the one or more filters may include one or more noise reduction filters.

According to some embodiments, the method may include putting together (or stitching) a plurality of signals obtained from two or more optical sensors. According to some embodiments, the method may include stitching a plurality of signals in real time.

According to some embodiments, the method may include identifying at least one segment within any one or more of the received signals, one or more images, one or more portions of the one or more images, one or more sets of images, and/or one or more videos. According to some embodiments, the method may include monitoring the (identified) at least one segment. According to some embodiments, the at least one change in the signals may be a change within the at least one segment. According to some embodiments, the at least one change in the one or more images, one or more portions of the one or more images, one or more sets of images, and/or one or more videos, may be a change within the at least one segment.

According to some embodiments, the user may mark a segment to be monitored onto an image and/or a portion of an image and/or at least a portion of a video. According to some embodiments, the user may input a location to be monitored. According to some embodiments, the algorithm may be configured to identify at least one segment within the location that the user inputted.

According to some embodiments, the method may include applying the one or more signals, the one or more images, the one or more portions of the one or more images, the one or more sets of images, and/or the one or more videos, to a change detection algorithm 1208 (such as, for example, one or more algorithms 1010 of system 1000) configured to detect a change therein. According to some embodiments, the change detection algorithm may include one or more machine learning models 1222.

According to some embodiments, the method may include detecting if there is a change in the shape of the at least one segment, size of the at least one segment, rate of occurrence of the at least one segment in the received signals, or any combination thereof. According to some embodiments, the method may include detecting if there is a change in the shape, size, and/or rate of occurrence, of the at least one segment, throughout time. According to some embodiments, the method may include detecting if there is a change in the shape, size, and/or rate of occurrence of the at least one segment, throughout a specified time period, such as, for example, a second, a few seconds, a minute, an hour, a day, a week, a few weeks, or any range therebetween.

According to some embodiments, the at least one segment may include a potential fault that needs to be monitored, such as, for example, a surface defect or a spring that may loosen. According to some embodiments, the at least one segment may include an outline of a byproduct of the spring and/or mechanism and/or associated element and/or vicinity of the mechanism, such as, for example, a fluid accumulation in the vicinity of the mechanism (for example damper fluid). According to some embodiments, the at least one segment may include the boundaries of a surface defect.

According to some embodiments, the at least one segment may include the boundaries of a specific element of the spring and/or mechanism and/or associated element. According to some embodiments, the method may include identifying a geometrical shape of the at least one segment as the specific element of the mechanism and/or associated element. According to some embodiments, the specific element may include any one or more of a coil, hook, screw, a connector, a bolt, a brake pad, a shock absorber, one or more vehicles components, motors, gear box, turbine components, cables, belts, wires, actuator, spring, fasteners, cylinders, blades, nuts, one or more flexible, semi-rigid, or rigid pipes/tubes, and any combination thereof. According to some embodiments, the method (or the identifying of the geometrical shape) may include analyzing any one or more of the total intensity, variance intensity, spackle detection, line segment detection, line segment registration, edge segment curvature estimation, homography estimation, specific object identification, object detection, semantic segmentation, background model, change detection, detection over optical flow, or reflection detection, or any combination thereof.

According to some embodiments, the method may include obtaining data associated with characteristics of at least one mode of failure of the mechanism and/or associated element, or mode of failure identification 1206. According to some embodiments, data associated with characteristics of at least one mode of failure of the mechanism and/or associated element may include a type of mode of failure. According to some embodiments, data associated with characteristics of at least one mode of failure of the mechanism and/or associated element may include a location or range of locations of the mode of failure on the mechanism and/or associated element and/or a specific type of mode of failure.

According to some embodiments, the mode of failure may include one or more aspects which may fail in the mechanism and/or associated element. According to some embodiments, and as described in greater detail herein, the mode of failure may include a critical development of an identified fault. According to some embodiments, the mode of failure may include any one of or more of a change in dimension, a change in position, a change in ability to expand and/or contract, change in spring pitch, a change in color, a change in texture, a change in size, a change in appearance, a fracture, a structural damage, a crack, crack size, critical crack size, crack location, crack propagation, a specified pressure applied to the spring and/or mechanism and/or associated element, a change in the movement of one component in relation to another component, defect diameter, cut, deformation, distortion, warping, inflation, deformation, abrasion, wear, corrosion, oxidation, a change in appearance, or any combination thereof.

According to some embodiments, the method may include obtaining data associated with characteristics of at least one mode of failure of the mechanism and/or associated element by receiving user input. According to some embodiments, the method may include obtaining data associated with characteristics of at least one mode of failure of the mechanism and/or associated element by analyzing the received signals and detecting at least one segment that may be associated with a mode of failure.

According to some embodiments, the method may include obtaining data associated with characteristics of at least one mode of failure of the mechanism and/or associated element by analyzing the received signals and detecting at least one segment that may be associated with a mode of failure. According to some embodiments, the method may include obtaining data associated with characteristics of at least one mode of failure of the mechanism and/or associated element by analyzing the received signals and detecting potential modes of failure. According to some embodiments, the method may include obtaining data associated with characteristics of at least one mode of failure of the mechanism and/or associated element by analyzing the received signals and detecting one or more modes of failure which were previously unknown.

According to some embodiments, obtaining data associated with characteristics of at least one mode of failure of the mechanism and/or associated element, includes receiving inputted data from a user. According to some embodiments, the user may input data associated with the mode of failure of the mechanism and/or associated element using the user interface module. According to some embodiments, the method may include monitoring the mechanism and/or associated element based, at least in part, on the received inputted data from the user. According to some embodiments, the user may input the type of failure mode of the mechanism and/or associated element. According to some embodiments, the user may input the type of failure mode associated with a specific identified segment. According to some embodiments, the user may input the location of the failure mode. According to some embodiments, the user may identify one or more of the at least one segments as being in a location likely to fail and/or develop a fault.

According to some embodiments, the method may include automatically obtaining data associated with characteristics of at least one mode of failure of the mechanism and/or associated element. According to some embodiments, the method may include obtaining data associated with characteristics of at least one mode of failure of the mechanism and/or associated element without user input. According to some embodiments, the method may include analyzing the received signal and automatically retrieving the data from a database, such as, for example, the database 1008. According to some embodiments, the one or more algorithm 1010 may be configured to identify one or more modes of failure, within the database, which may be associated with the identified segment of the received signals of the spring and/or object attached thereto. According to some embodiments, the method may include searching the database for possible failure modes of the identified segment. According to some embodiments, the method may include retrieving data, from the database, wherein the data may be associated with possible failure modes of the identified segment.

According to some embodiments, the method may include obtaining data associated with characteristics of at least one mode of failure of the mechanism and/or associated element thereof by identifying a previously unknown failure mode. According to some embodiments, identifying a previously unknown failure mode may include applying the received signals and/or the identified segment to a machine learning algorithm 1224 configured to determine a mode of failure of the mechanism and/or associated element. According to some embodiments, the machine learning algorithm 1224 may be trained to identify a potential failure mode of the identified segment.

According to some embodiments, at step 1104, the method may include identifying at least one change in the received signals and/or the at least one identified segment. According to some embodiments, the method may include applying the received signals and/or the at least one identified segment to a change detection algorithm such as for example, change detection algorithm 1208, configured to detect (or identify) at least one change in the received signals and/or the at least one identified segment.

According to some embodiments, identifying at least one change in the signals includes identifying a change in the rate of change in the signals. For example, the algorithm may be configured to identify a change that occurs periodically within the analyzed signals, then the analyzed signals may “return” to the previous state (e.g., prior to the change in the analyzed signals). According to some embodiments, the algorithm may be configured to identify a change in the rate of occurrence of the identified change.

Optionally, for a monitoring of a mechanism and/or associated element that may expand and/or contract, such as, for example, a damper, the analyzed signals received from optical sensors positioned in the vicinity of the spring and/or mechanism and/or associated element may change periodically in correlation with the expansion and/or contraction of the spring. Thus, and as described in greater detail elsewhere herein, for detecting a change in the spring, the algorithm may detect first the periodical appearance of a defect on the spring, while taking into account the expansion and/or contraction of the spring which may cover the defect when blocking the optical sensors.

According to some embodiments, the term “analyzed signals” as used herein may describe any one or more of the received signals, such as raw signals from the one or more optical sensor, processed or preprocessed signals from the one or more optical sensor, one or more images, one or more packets of images, one or more portions of one or more images, one or more videos, one or more portions of one or more videos, at least one identified segment, at least a portion of an identified segment, or any combination thereof. According to some embodiments, identifying the at least one change in the analyzed signals may include analyzing raw data of the received signals.

According to some embodiments, the change detection algorithm 1208 may include any one or more of a binary change detection, a quantitative change detection, and a qualitative change detection, a change in the absolute value of at least one defined parameter, a change in the deviation of at least one defined parameter, change from a predefined, precalculated and/or calibrated value, etc.

According to some embodiments, the binary change detection may include an algorithm configured to classify the analyzed signals as having a change or not having a change. According to some embodiments, the binary change detection may include an algorithm configured to compare two or more of the analyzed signals. According to some embodiments, for a comparison that shows the compared analyzed signals are the same, or essentially the same, the classifier labels the analyzed signals as having no detected (or identified) change. According to some embodiments, for a comparison that shows the compared analyzed signals are different, the classifier labels the analyzed signals as having a detected (or identified) change. According to some embodiments, two or more analyzed signals that are different may have at least one pixel that may be different. According to some embodiments, two or more analyzed signals that may be the same may have identical characteristics and/or pixels. According to some embodiments, the algorithm may be configured to set a threshold number of different pixels above which two analyzed signals may be considered as different.

Optionally, the change detection algorithm 1208 enables fast detection of changes in the analyzed signaling and may be very sensitive to the slightest changes therein. Even more so, the detection and warning of the binary change detection may take place within a single signal, e.g., within a few milliseconds, depending on the signal outputting rate of the optical sensor, or for an optical sensor comprising a camera, a within a single image frame, e.g., within a few milliseconds, depending on the frame rate of the camera.

According to some embodiments, the binary change detection algorithm may, for example, analyze the analyzed signals and determine if a non-black pixel changes to black over time, thereby indicating a possible change in the position of the spring and/or mechanism and/or associated element, perhaps due to deformation or due to a change in the position of other components of the mechanism and/or associated element. According to some embodiments, if the binary change detection algorithm detects a change in the signals, a warning signal (or alarm) may be generated in order to alert the equipment or a technician that maintenance may be required.

According to some embodiments, the binary change detection algorithm may be configured to determine the cause of the identified change using one or more machine learning models. According to some embodiments, the method may include determining the cause of the identified change by applying the identified change to a machine learning algorithm. For example, for a black pixel that may change over time (or throughout consecutive analyzed signals) to a color other than black, the machine learning algorithm may output that the change may be indicative of a change in the material of the spring, for example, due to overheating. According to some embodiments, the method may include generating a signal, such as an informational signal or a warning signal, if necessary. According to some embodiments, the warning signal may be a one-time signal or a continuous signal, for example, which might require some form of action in order to reset the warning signal.

According to some embodiments, the method may include identifying the at least one change in the signals by analyzing dynamic movement of the spring. According to some embodiments, the dynamic movement may include any one or more of linear movement, non-linear movement, vertical movement, rotational movement, periodic (repetitive) movement, and oscillating movement.

According to some embodiments, the method may include identifying damage, distortion, defect, crack size/length, crack growth rate, crack propagation, fracture, structural damage, defect diameter, cut, warping, inflation, deformation, abrasion, wear, corrosion, oxidation, smoke, fluid flow rate, drop size, fluid volume, rate of accumulation of liquid, change in texture, change in color/shade, size of formed bubbles, a change in dimension, a change in position, a change in texture, change in size, a change in appearance, or any combination thereof.

According to some embodiments, the change detection may include a quantitative change detection. According to some embodiments, the quantitative change detection may include an algorithm configured to determining whether a magnitude of change above a certain threshold has occurred in the analyzed signals. According to some embodiments, the magnitude of change above a certain threshold may include a cumulative change in magnitude regardless of time, and/or a rate (or rates) of change in magnitude. For example, the value reflecting a change in magnitude may represent a number of pixels that have changed, a percentage of pixels that have changed, a total difference in the numerical values of one or more pixels within the field of view (or the analyzed signals), combinations thereof and the like. According to some embodiments, the quantitative change detection algorithm may output quantitative data associated with the change in the analyzed signals.

According to some embodiments, the change detection may include a qualitative change detection algorithm. According to some embodiments, the qualitative change detection algorithm may include an algorithm configured to classify the analyzed signals as depicting a change in the spring and/or mechanism and/or associated element. According to some embodiments, the qualitative change detection algorithm may include a machine learning model configured to receive the analyzed signals and to classify the analyzed signals into categories including at least: including a change in the behavior of the spring and/or mechanism and/or associated element, and not including a change in the behavior of the spring and/or mechanism and/or associated element.

According to some embodiments, the change detection algorithm may be configured to analyze, with the assistance of a machine learning model, other more complex changes in the analyzed signals generated by the optical sensors. According to some embodiments, the machine learning model may be trained to recognize complex, varied changes. According to some embodiments, the machine learning model may be able to identify complex changes, such as, for example, for signals generated by the optical sensors that may begin to exhibit some periodic instability, such that the signals can appear normal for a time, and then abnormal for a time before appearing normal once again. Subsequently, the signals may exhibit some abnormality that may be similar but different than before, and the change detection algorithm may be configured to analyze changes and, over time, train itself to detect the likely cause of the instability. According to some embodiments, the change detection algorithm may be configured to generate a warning signal or an informational signal, if necessary, for a user to notice the changes in the spring and/or mechanism and/or associated element.

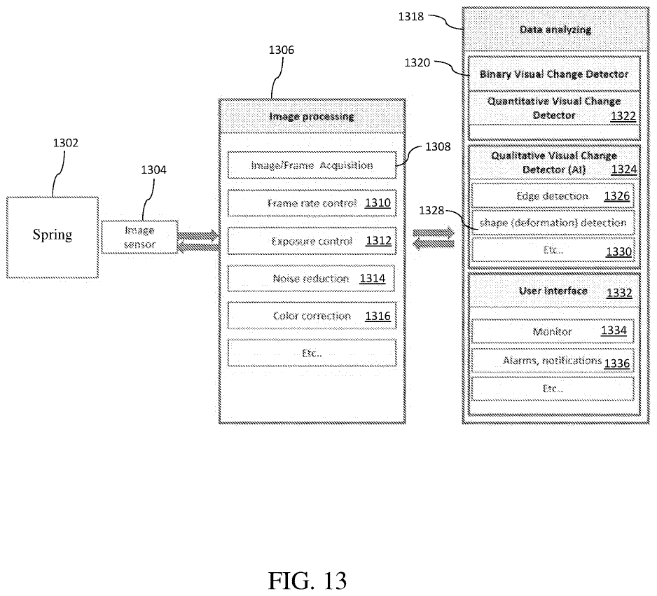

Reference is made to FIG. 13, which shows an exemplary simplified schematic block diagram of the system for monitoring potential failure in a mechanism and/or associated element, in accordance with some embodiments of the present invention.

As depicted in the exemplary systems of FIG. 13, the optical sensor may capture image data of spring 1302. According to some embodiments, the optical sensor may generate signals, such as, for example, images or video, and send the generated signals to an image processing module 1306. According to some embodiments, the image processing module processes the signals generated by the optical sensor (or the image sensor 1304 of FIG. 13), such that the data can be analyzed by the data analysis module 1318 (or algorithms 1010 as described herein). According to some embodiments, the image processing module 1306 may include any one or more of an image/frame acquisition module 1308, a frame rate control module 1310, an exposure control module 1312, a noise reduction module 1314, a color correction module 1316, and the like. According to some embodiments, the data analysis module 1318 (or algorithms 1010 as described herein) may include the change detection algorithm such as for example, change detection algorithm 1208. According to some embodiments, the user interface module 1332 (described below) may issue any warning signals resulting from the signal analysis performed by the algorithms. According to some embodiments, any one or more of the signals, and/or the algorithms, may be stored on a cloud storage 602. According to some embodiments, the processor may be located on a cloud, such as, which may cooperate with an embedded processor.

According to some embodiments, the data analyzing module 1318 may include any one or more of a binary (visual) change detector 1320 (or binary change detection algorithm as described in greater detail elsewhere herein), quantitative (visual) change detector 1322 (or quantitative change detection algorithm as described in greater detail elsewhere herein), and/or a qualitative (visual) change detector 1324 (or qualitative change detection algorithm as described in greater detail elsewhere herein). According to some embodiments, the qualitative (visual) change detector 1324 may include any one or more of edge detection 1326 and/or shape (deformation) detection 1328. According to some embodiments, the data analyzing module 1318 may include and/or be in communication with the user interface module 1332. According to some embodiments, and as described in greater detail elsewhere herein, the user interface module 1332 may include a monitor 1334. According to some embodiments, the user interface module 1332 may be configured to output the alarms and/or notifications 1336/1226.

According to some embodiments, the change detection algorithm such as for example, change detection algorithm 1208, may be implemented on an embedded processor, or a processor in the vicinity of the optical sensor. Thus, the change detection algorithm such as for example, change detection algorithm 1208, may enable a quick detection and prevent lag time associated with sending data to a remote server (such as a cloud).

According to some embodiments, once a change is identified using the change detection algorithm, the identified change may be classified using a classification algorithm. According to some embodiments, at step 1106, the method may include analyzing the identified change in the received signals (or the analyzed signals), classifying whether the identified change in the received signals may be associated with a mode of failure of the spring or object affected by and/or attached thereto, an labeling identified changes identified with a mode of failure as a fault. According to some embodiments, the method may include applying the received signals (or the analyzed signals) to an algorithm configured to analyze the identified change in the received signals and to classify whether the identified change in the received signals may be associated with a mode of failure of the mechanism and/or associated element based, at least in part, on the obtained data.

According to some embodiments, the method may include applying the identified change to an algorithm configured to match between the identified change and the obtained data associated with the mode of failure. According to some embodiments, the algorithm may be configured to determine whether the identified change may potentially develop into one or more modes of failure. According to some embodiments, the algorithm may be configured to determine whether the identified change may potentially develop into one or more modes of failure based, at least in part, on the obtained data. According to some embodiments, the method may include labeling the identified change as a fault if the algorithm determines that that identified change may potentially develop into one or more modes of failure.

For example, an identified change of a surface defect and/or crack may be identified as a fault once the crack or defect reaches a certain size or length and may be associated with a mode of failure that may be a critical crack size or critical defect size.

For example, in an identified change of ability of the spring to expand and/or contract, a fault may be identified.

For example, where an identified change may include a texture or color of a component of the spring, the fault may be identified as corrosion, and the mode of failure may be an amount of corrosion or depth of corrosion within the component.

According to some embodiments, the fault may include any one or more of structural damage, a crack, a defect, a distortion, a predetermined crack size and/or length, crack growth rate, crack propagation, fracture, defect diameter, cut, warping, inflation, deformation, abrasion, wear, corrosion, oxidation, sparks, smoke, fluid flow rate, drop formation, drop size, change in texture, change in color/shade, size of formed bubbles, a change in dimension of at least a portion of the segment, a change in position of at least a portion of the segment, a change in color of at least a portion of the segment, a change in texture of at least a portion of the segment, change in size of at least a portion of the segment, a change in appearance of at least a portion of the segment, linear movement of at least a portion of the segment, rotational movement of at least a portion of the segment, periodic (repetitive) movement of at least a portion of the segment, a change in the rate of movement of at least a portion of the segment, or any combination thereof.

According to some embodiments, the algorithm may identify the fault using one or more machine learning models. According to some embodiments, and as described in greater detail elsewhere herein, the machine learning model may be trained over time to identify one or more faults. According to some embodiments, the machine learning models may be trained to identify previously unknown faults by analyzing a baseline behavior of the spring and/or mechanism and/or associated element.

Optionally, identifying the fault using a machine learning model enables the detection of different types of faults, or even similar faults that may appear different in different machinery or situations, or even different angles of the optical sensors. Thus, the machine learning model may increase the sensitivity of the detection of the one or more faults.

According to some embodiments, the system and/or the one or more algorithms may include one or more suppressor algorithms 1210 (also referred to herein as suppressors 1210). According to some embodiments, the one or more suppressor algorithms may be configured to classify the whether the detected fault may develop into a failure or not, such as depicted by the mode of failure junction 1212 of FIG. 12. According to some embodiments, the one or more suppressor algorithms 1210 may include one or more machine learning models 1220. According to some embodiments, the one or more suppressor algorithms 1210 may classify a fault and/or a propagating fault as harmless.

According to some embodiments, at step 1108, for an identified fault, the method may include outputting a signal, such as a warning signal, indicative of the identified change associated with the mode of failure. According to some embodiments, the method may include storing the identified change in the database, thereby increasing the data set for training the one or more machine learning models.

According to some embodiments, the method may include labeling data associated with any one or more of the mode of failure identification 1206, change detection algorithm 1208, the suppressors 1210, and the classification as depicted by the mode of failure junction 1212. According to some embodiments, the method may include supervised labeling 1216, such as manual labeling of the data using user input (or expert knowledge).

According to some embodiments, if the identified change may not be classified as being associated with a mode of failure (such as depicted by arrow 1250 of FIG. 12), it may be identified (or classified) as normal, or in other words, normal behavior or operation of the spring and/or mechanism and/or associated element. According to some embodiments, for an identified change classified as normal, the method may include storing data associated with the identified change, thereby adding the identified change to the database and increasing the data set for training 1218 the one or more machine learning models (such as, for example, the one or more machine learning models 1220/1222/1224). According to some embodiments, the method may include using data associated with the identified change for further investigation, wherein the further investigation includes at least one of adding a mode of failure, updating the algorithm configured to identify the change, and training the algorithm to ignore the identified change in the future, thereby improving the algorithm configured to identify the change.

According to some embodiments, if the identified change may be classified as being associated with a mode of failure (such as depicted by arrow 1255 of FIG. 12), the method may include trend analysis and failure prediction 1214. According to some embodiments, at step 1110, the method may include generating at least one model of a trend in the identified fault. According to some embodiments, the method may include generating at least one model of the trend based on a plurality of analyzed signals.

According to some embodiments, the method may include generating at least one model of the trend by calculating the development of the identified change within the analyzed signals over time. According to some embodiments, the trend may include a rate of change of the fault. According to some embodiments, the method may include generating the at least one model of trend in the identified fault by calculating a correlation of the rate of change of the fault with one or more environmental parameters and/or physical parameters.

According to some embodiments, the one or more environmental parameters may include any one or more of temperature, season or time of the year, pressure, time of day, hours of operation of the mechanism and/or associated element, duration of operation of the mechanism and/or associated element, an identified user of the mechanism and/or associated element (such as, for example, a specific driver or pilot), GPS location (or location or country in the world), mode of operation of the mechanism and/or associated element, or any combination thereof.

According to some embodiments, the one or more physical parameter may include wire diameter, coil pitch, linear or non-linear spring, coil inner or outer diameter, spring length, spring stiffness, spring material, spring ends, composition of the spring, location of a spring, shape of an object to which a spring is attached, mass of an object to which a spring is attached, damping coefficient, frequency of oscillation of a spring or object affected by and/or attached thereto, etc. or any combination thereof.

According to some embodiments, the mode of operation of the spring and/or mechanism and/or associated element may include any one or more of the distance the spring and/or coil traveled or moved or expanded or compressed or distorted, the frequency of motion, the velocity of motion, the power consumption during operation, the changes in power consumption during operation, and the like. According to some embodiments, generating the at least one model of trend in the identified fault by calculating a correlation of the rate of change of the fault with one or more environmental parameters may include taking into account the different influences in the surrounding of the spring and/or mechanism and/or associated element. According to some embodiments, the method may include mapping the different environmental parameters effecting the operation of the spring and/or mechanism and/or associated element, wherein the environmental parameters may vary over time.

According to some embodiments, at step 1112, the method may include alerting a user of a predicted failure based, at least in part, on the generated model. According to some embodiments, the method may include outputting notifications and/or alerts 1226 to the user. According to some embodiments, the method may include alerting a user of the predicted failure. According to some embodiments, the method may include alerting the user of a predicted failure by outputting any one or more of: a time (or range of times) of a predicted failure and characteristics of the mode of failure, or any combination thereof. According to some embodiments, the method may include outputting a prediction of when the identified fault may likely lead to failure in the mechanism and/or associated element, based, at least in part, on the generated model. According to some embodiments, the predicting of when a failure may likely occur in the mechanism and/or associated element may be based, at least in part, on predicted future environmental parameters. According to some embodiments, the predicting of when a failure may likely occur in the mechanism and/or associated element may be based, at least in part, on a known schedule, such as, for example, a calendar.

According to some embodiments, the system for monitoring potential failure in a mechanism and/or associated element, such as, for example, system 1000, may include one or more light sources configured to illuminate at least a portion of the vicinity of the spring and/or mechanism and/or associated element. According to some embodiments, the one or more light sources may include any one or more of a light bulb, light-emitting diode (LED), laser, a fiber light source, fiber optic cable, and the like. According to some embodiments, the user may input the location (or position) of the light source, the direction of illumination of the light source (or in other words, the direction at which the light may be directed), the duration of illumination, the wavelength, the intensity, and/or the frequency of illumination of the light source in relation to the one or more optical sensor. According to some embodiments, the one or more algorithms may be configured to automatically locate the one or more light sources. According to some embodiments, the one or more algorithms may instruct the operation mode of the one or more light sources. According to some embodiments, the one or more algorithms may instruct and/or operate any one or more of the illumination intensities of the one or more light sources, the number of powered light sources, the position of the powered light sources, and the wavelength, the intensity, and/or the frequency of illumination of the one or more light sources, or any combination thereof. According to some embodiments, the one or more algorithms may instruct and/or operate wavelengths in the visible spectrum. According to some embodiments, the one or more algorithms may instruct and/or operate wavelengths above and/or below the visible spectrum.

Optionally, an algorithm configured to instruct and/or operate the one or more light sources may increase the clarity of the received signals by reducing darker areas (such as, for example, areas from which light may not be reflected and/or areas that were not illuminated) and may fix (or optimize) the saturation of the received signals (or images).

According to some embodiments, the one or more algorithms may be configured to detect and/or calculate the position in relation to the one or more optical sensors, the duration of illumination, the wavelength, the intensity, and/or the frequency of illumination of the one or more light sources. According to some embodiments, the one or more algorithms may be configured to detect and/or calculate the position in relation to the one or more optical sensors, the duration of illumination, the wavelength, the intensity, and/or the frequency of illumination of the one or more light sources based, at least in part, on the analyzed signals. According to some embodiments, the processor may control the operation of the one or more light sources. According to some embodiments, the processor may control any one or more of the duration of illumination, the wavelength, the intensity, and/or the frequency of illumination of the one or more light sources.

According to some embodiments, the method may include obtaining the position, the duration of illumination, the wavelength, the intensity, and/or the frequency of illumination, of the one or more light sources in relation to the one or more optical sensors. According to some embodiments, the method may include obtaining the position of the one or more light sources via any one or more of a user input, detection, and/or using the one or more algorithms. According to some embodiments, classifying whether the identified change in the (analyzed) signals is associated with a mode of failure of the mechanism and/or associated element may be based, at least in part, on any one or more of the placement(s) of the at least one light source, the duration of illumination, the wavelength, the intensity, and the frequency of illumination.

According to some embodiments, the method may include outputting data associated with an optimal location for placement (or location) of the optical sensor, from which potential modes of failure can be detected. According to some embodiments, the one or more algorithms may be configured to calculate at least one optimal location for placement (or location) of the one or more optical sensor, based, at least in part, on the obtained data, data stored in the database, and/or user inputted data.

According to some embodiments, the light source may illuminate the spring with one or more wavelengths from a wide spectrum range, visible and invisible. According to some embodiments, the light source may include a strobe light, or a light source configured to illuminate in short pulses. According to some embodiments, the light source may be configured to emit strobing light without use of global shutter sensors.

According to some embodiments, the wavelengths may include any one or more of light in the ultraviolet region, the infrared region, or a combination thereof. According to some embodiments, the one or more light sources may be mobile, or moveable. According to some embodiments, the one or more light sources may change the outputted wavelength during operation, change the direction of illumination during operation, changes one or more lenses, and the like. According to some embodiments, the light source may be configured to change the lighting using one or more fiber optics (FO), such as, for example, by using different fibers to produce the light at different times, or by combining two or more fibers at once. According to some embodiments, the fiber optics may include one or more light sources attached thereto, such as, for example, an LED. According to some embodiments, the light intensity and/or wavelength of the LED may be changed, as described in greater detail elsewhere herein, using one or more algorithms.

Optionally, illuminating the spring and/or an object attached thereto may enable the optical sensor to detect faults and/or surface defects and/or structural defects by analyzing shadows and/or reflections. For example, a surface defect may generate a shadow that can be analyzed by the one or more algorithms and detected as a surface defect.

Optionally, illuminating the spring and/or an object attached thereto while receiving the optical signals from the one or more optical sensors may enable detection of surface defects and/or changes and/or faults that may not be visible to the human eye. According to some embodiments, the size of the defects and/or faults and/or the deviations from predefined values may range between about 10 micrometers and 5 mm, between about 5 mm and 10 mm, between about 10 mm and 50 mm, between about 50 mm and 1 m, or between about 1 m and 5 m. According to some embodiments, the size of the defects and/or faults and/or the deviations from predefined values may be less than 5 mm. According to some embodiments, the degree of distortion or deformation of the defects and/or faults and/or the deviations from predefined values may range between about 0.1° to 1°, between about 1° to 5°, between about 5° to 10°, between about 10° to 20°, between about 20° to 50°, between about 50° to 75°, between about 75° to 90°. As used within this paragraph, the term “about” refers to ±20%.

For example, the total length of the spring in its resting state 702 may be compared to the length of the spring in its expanded and/or contracted state, and how this value changes over time may be an indication of wear and/or fluid leakage, etc. For example, the distance between several coils of the spring in its resting state 704 may be compared or the distance between several coils of the spring in its expanded and/or contracted state may be compared, and how these values change over time may be an indication of wear and/or fluid leakage, damage by rotation, weakening of a particular segment of the spring, etc. Optionally, a number of optical sensor may view different areas of the spring and/or object attached thereto and may allow calculation of the displacement and/or forces applied to the spring and/or object attached thereto.

According to some embodiments the terms “normal” or “normally” refer to behavior (e.g., movement) of parts (reference points) in a fully functional, intact system.

According to some embodiments, the terms “expand” and “extend”, and “expansion” and “extension” are used interchangeably.

### GENERAL

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. For example, methods, sensors, illumination, processing circuitry described with some embodiments may be used with other embodiments as well. Features described in the context of various embodiments are not to be considered essential features of those embodiments unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or document(s) related to this application (e.g., co-filed) are hereby incorporated herein by reference in its/their entirety.

Where section headings are used in this document, they should not be interpreted as necessarily limiting.

1.-66. (canceled)

67. A system for monitoring a mechanism comprising a damper and a spring, said system comprising a processing circuitry configured to:
input image data of at least one section of a spring associated with said damper from at least one optical sensor mounted within a body of said damper; and
provide an indicator of a health of said damper based on an analysis of said image data.

68. The system of claim 67, wherein said optical sensor is mounted within fluid of a viscous damper.

69. The system according to claim 67, further comprising at least one light element positioned to illuminate at least a portion of said at least one section of said spring during image data capture by said optical sensor.

70. The system according to claim 67, wherein said analysis comprises determining, from said image data, a respective conformance of at least one parameter value of said spring to a specified range of said parameter.

71. The system of claim 67, wherein said analysis comprises determining events that occurred to said damper.

72. The system of claim 67, wherein said indicator is indicative of a health of components of said damper other than said spring.

73. The system of claim 67, wherein said processing circuitry is further configured to control said at least one optical sensor to synchronize image data capture during a strobe light pulse.

74. The system of claim 67, wherein said analysis comprises determining, from said image data, a respective conformance of at least one parameter value of said spring to a specified range of said parameter,
wherein said at least one parameter comprises one or more of:
a characteristic of a surface of a wire forming said spring;
an angle of coils of said spring;
a pitch of coils of said spring; or
a shape of a wire forming said spring to a baseline shape of said wire.

75. The system of claim 67, wherein said analysis comprises comparing an expected length of said spring under a known force or in an absence of force to a current length of said spring.

76. The system of claim 67, wherein said analysis comprises calculating a movement of a reference point on said spring in a plurality of images.

77. The system of claim 67, wherein said analysis comprises comparing a rate of change of a distance between reference points on respective coils of said spring to an expected rate of change of said distance.

78. The system of claim 67, wherein said analysis comprises comparing a rate of change of at least one parameter of said spring to an expected rate of change of said parameter.

79. The system of claim 67, wherein said analysis is further based on known physical properties of said spring.

80. The system of claim 67, wherein the processing circuitry is further configured to calculate a position, velocity, trajectory, acceleration, stability, or combination thereof of an object connected to the damper based on an analysis of said image data.

81. The system of claim 80, wherein said processing circuitry is further configured to control an operation of said object based on said analysis, so as to prevent operation of said object during failure.

82. The system of claim 81, wherein an operation of said object is controlled in real-time based on said analysis.

83. The system of claim 1, wherein said indicator comprises at least one of:
maintenance instructions;
a time to failure estimation;
a failure alert;
a trend towards failure; and
operating instructions in response to a detected failure.

84. The system of claim 83, wherein said analysis further comprises predicting a future health of said mechanism by performing trend analysis.

85. A computer-implemented method for monitoring a mechanism comprising a damper and a spring, comprising:
receiving, by at least one processor, image data of at least one section of a spring associated with said damper from at least one optical sensor mounted within a body of said damper; and
providing, by the at least one processor, an indicator of a health of said damper based on an analysis of said image data.

86. The method of claim 19, wherein said optical sensor is mounted within a body of said damper
